(19) United States
(12) Patent Application Publication
(10) Pub. No.: US 2024/0341316 A1
(43) Pub. Date: Oct. 17, 2024

(54) PROBIOTIC MUCILAGE-BASED EDIBLE FILMS FOR THE PRESERVATION OF FRUITS AND VEGETABLES

(71) Applicant: CORNELL UNIVERSITY, Ithaca, NY (US)

(72) Inventors: Alireza ABBASPOURRAD, Ithaca, NY (US); Seyed Mohammad DAVACHI, Ithaca, NY (US)

(21) Appl. No.: 18/683,084

(22) PCT Filed: Aug. 11, 2022
(86) PCT No.: PCT/US2022/040031

§ 371 Date: Feb. 12, 2024

Related U.S. Application Data
(60) Provisional application No. 63/232,743, filed on Aug. 13, 2021.

(51) Int. Cl. A23B 7/16; A23B 7/155; A23L 29/206; A23L 33/135

(52) U.S. Cl. CPC A23B 7/16; A23B 7/155; A23L 29/206; A23L 33/135

(57) ABSTRACT

An edible film comprising a dried mucilage and a probiotic dispersed in the dried mucilage, wherein the mucilage may be obtained from, for example, seeds, leaves, middle lamella, fruit, bark, or root of a plant, and wherein the probiotic may be a Lactobacillus, or more particularly, Lactobacillus rhamnosus. Also described herein is a method of preparing an edible film comprising: (i) obtaining a mucilage aqueous solution: (ii) adding a probiotic to the warmed mucilage aqueous solution at a temperature of 30-50° C. to generate a probiotic-containing mucilage solution; (iii) mixing the probiotic-containing mucilage solution; (iv) forming a film of the probiotic-containing mucilage solution on a non-stick surface; and (v) drying the film of the probiotic-containing mucilage solution to produce the edible film. Also described herein is a method of coating produce with the edible film to increase the lifetime and nutritive value of the produce.

### CROSS REFERENCE TO RELATED APPLICATIONS

This application claims the benefit of priority from U.S. Provisional Application No. 63/232,743, filed on Aug. 13, 2021, which is herein incorporated by reference in its entirety.

### FIELD OF THE INVENTION

The present invention generally relates to methods for preserving and increasing the nutritive value of produce, such as fruits and vegetables. The present invention more particularly relates to preserving and increasing the nutritive value of produce by applying a protective-nutritive edible film as a coating on the produce.

### BACKGROUND OF THE INVENTION

Fruits and vegetables are known to be highly perishable foods. Approximately 30% of vegetables and fruits harvested for human consumption are lost due to spoilage, resulting in significant waste (Marelli et al., Scientific Reports, 6(1), 25263, 2016). Aside from the financial losses and inequity in food access that such waste poses, such waste is known to contribute to methane production, a particularly potent greenhouse gas. Thus, there have been ongoing efforts in preserving produce. The principal objective in food preservation is increasing the shelf life of products while maintaining original color, texture, and freshness under external stresses. However, conventional food preservation methods, such as drying, freezing, chilling, pasteurization, and chemical preservation often result in nutrient loss and the introduction of undesirable synthetic chemicals. Thus, there would be a significant benefit in a natural and green alternative for fruit and vegetable preservation that both protects and adds nutritional value.

### SUMMARY OF THE INVENTION

In a first aspect, the present disclosure is directed to novel edible films that both preserve and adds nutritive value to produce, such as fruits and vegetables. The edible film includes dried mucilage and a probiotic dispersed in the dried mucilage. The dried mucilage may be obtained from, for example, seeds, leaves, middle lamella, fruit, bark, or root of a plant. In particular embodiments, the dried mucilage is obtained from seeds, such as quince seed, flax seed, basil seed, or combination thereof. In particular embodiments, the probiotic is or includes Lactobacillus, or more particularly, Lactobacillus rhamnosus. In some embodiments, the edible film includes dried mucilage obtained from seeds, such as quince seed, flax seed, basil seed, or combination thereof, or more particularly quince seed, in combination with a Lactobacillus (or more particularly, Lactobacillus rhamnosus) probiotic. In some embodiments, the edible film further includes a plasticizer, such as glycerol. In some embodiments, the edible film includes dried mucilage obtained from seeds, such as quince seed, flax seed, basil seed, or combination thereof, or more particularly quince seed, in combination with a Lactobacillus (or more particularly. Lactobacillus rhamnosus) probiotic, and further includes a plasticizer, such as glycerol.

The edible film, such any of those described above, preferably has a tensile strength of 5-20 MPa, or more preferably 10-20 MPa. The edible film, such any of those described above, preferably has an elastic modulus of 200-500 MPa, or more preferably 300-500 MPa. The edible film, such any of those described above, preferably has an elongation at break of 30-60%, or more preferably 35-60% or 40-60%. The edible film, such any of those described above, preferably has a thickness of 50-150 microns, or more preferably 100-130 microns. The edible film, such any of those described above, preferably has a moisture content of greater than 90%, 92%, 93%, 94%, or 95%. The edible film, such any of those described above, preferably has a water activity below 0.6 or 0.5. The edible film, such any of those described above, preferably exhibits a probiotic viability of at least 7.0 log CFU/g after 21 days at room temperature. The edible film, such any of those described above, preferably possesses a water vapor permeability (WVP) of no more than 40×10⁻⁸ g/h·m·Pa after 14 days. In some embodiments, the edible film, such any of those described above, possesses a combination of any one or more of the tensile strengths, elastic moduli, elongation at break, thicknesses, moisture contents, water activities, probiotic viability, and WVP values provided above.

In a second aspect, the present disclosure is directed to a method for producing any of the edible film compositions described above. The method includes the following steps: (i) obtaining a mucilage aqueous solution; (ii) adding a probiotic to the warmed mucilage aqueous solution at a temperature of 30-50° C. to generate a probiotic-containing mucilage solution; (iii) mixing the probiotic-containing mucilage solution; (iv) forming a film of the probiotic-containing mucilage solution on a non-stick surface; and (v) drying the film of probiotic-containing mucilage solution (optionally, under vacuum) to produce said edible film. The method may further include the following steps for obtaining the mucilage aqueous solution obtained in step (i): (a) washing mucilage-containing plant material; (b) soaking and stirring the mucilage-containing plant material in water at a temperature of 70-90° C. until a viscous gel-like suspension forms in which mucilage from the plant material is extracted from the plant material into the water; and (c) subjecting the viscous gel-like suspension to a separation process in which the plant material is removed from the viscous gel-like suspension to provide the mucilage aqueous solution. In some embodiments, the washing process in step (a) comprises washing the mucilage-containing plant material in a food grade organic solvent and evaporating the food grade organic solvent, wherein the food grade organic solvent may be, e.g., ethanol. In some embodiments, the separation process in step (c) comprises a filtration process, centrifugation process, or combination thereof. In some embodiments, the method of obtaining the mucilage aqueous solution further includes the following step: (d) adding a plasticizer (e.g., glycerol) under stirring condition to the mucilage aqueous solution.

In embodiments of the method of making the edible film, the mucilage may be obtained from, for example, seeds, leaves, middle lamella, fruit, bark, or root of a plant. In particular embodiments of the method, the mucilage is obtained from seeds, such as quince seed, flax seed, basil seed, or combination thereof. In particular embodiments of the method, the probiotic is or includes Lactobacillus, or more particularly, Lactobacillus rhamnosus. In some embodiments of the method, the mucilage is obtained from seeds, such as quince seed, flax seed, basil seed, or combination thereof, or more particularly quince seed, and the probiotic is or includes a Lactobacillus, or more particularly, Lactobacillus rhamnosus. In some embodiments of the method, the method incorporates a plasticizer, such as glycerol, into the mucilage aqueous solution. In some embodiments of the method, the mucilage is obtained from seeds, such as quince seed, flax seed, basil seed, or combination thereof, or more particularly quince seed, and the probiotic is or includes a Lactobacillus, or more particularly, Lactobacillus rhamnosus, and a plasticizer, such as glycerol, is incorporated into the mucilage aqueous solution.

Any one of the edible films produced by any of the above described methods preferably has a tensile strength of 5-20 MPa, or more preferably 10-20 MPa. Any one of the edible films produced by any of the above described methods preferably has an elastic modulus of 200-500 MPa, or more preferably 300-500 MPa. Any one of the edible films produced by any of the above described methods preferably has an elongation at break of 30-60%, or more preferably 35-60% or 40-60%. Any one of the edible films produced by any of the above described methods preferably has a thickness of 50-150 microns, or more preferably 100-130 microns. Any one of the edible films produced by any of the above described methods preferably has a moisture content of greater than 90%, 92%, 93%, 94%, or 95%. Any one of the edible films produced by any of the above described methods preferably has a water activity below 0.6 or 0.5. Any one of the edible films produced by any of the above described methods preferably exhibits a probiotic viability of at least 7.0 log CFU/g after 21 days at room temperature. Any one of the edible films produced by any of the above described methods preferably possesses a water vapor permeability (WVP) of no more than 40×10⁻⁸ g/h·m·Pa after 14 days. In some embodiments, any one of the edible films produced by any of the above described methods possesses a combination of any one or more of the tensile strengths, elastic moduli, elongation at break, thicknesses, moisture contents, water activities, probiotic viability, and WVP values provided above.

In a third aspect, the present disclosure is directed to a method for extending the lifetime and increasing the nutritive value of a fruit or vegetable. The method includes the following steps: (i) coating the fruit or vegetable with a probiotic-containing mucilage solution; and (ii) drying the coating to produce an edible film comprising dried mucilage and the probiotic dispersed in the dried mucilage. In some embodiments, the probiotic-containing mucilage solution is coated onto the fruit or vegetable by dipping or spraying the fruit or vegetable with the probiotic-containing mucilage solution. In specific embodiments, the fruit or vegetable may be selected from, for example, strawberry, cucumber, tomato, or banana. The probiotic-containing mucilage solution may be any of those described above and may be prepared by any of the methods of preparation described above.

### BRIEF DESCRIPTION OF THE FIGURES

FIG. 1. FTIR spectra of edible films (based on quince, flax, and basil) with and without LGG after 1 month at 4° C. No noticeable difference was observed between the samples. The “B” in Quince-B. Flax-B, and Basil-B indicates presence of probiotic, while absence of B represents absence of probiotic.

FIG. 2. Graph plotting WVP (water vapor permeability) of mucilage films with and without probiotic LGG. Reported values are shown as the mean (n=3)±standard deviation. From left to right in each group the order is Quince, Flax, Basil, Quince-B, Flax-B and Basil-B.

FIG. 3, panels (a)-(f). SEM images and elemental mapping of the surface of edible films derived from: Quince (panel a), Flax (panel b), Basil (panel c), Quince-B (panel d), Flax-B (panel e), and Basil-B (panel f). The red and green dots represent the presence and dispersion of C and O, respectively. In the samples with LGG, in addition to C and O, the blue and purple dots represent the presence of N and P, respectively, which belong to amino acids of probiotics.

FIG. 4, panels (a)-(f). Laser scanning confocal microscopy 2D and 3D images of edible films derived from: Quince (panel a), Flax (panel b), Basil (panel c), Quince-B (panel d), Flax-B (panel e), and Basil-B (panel f).

FIG. 5, panels (a)-(d). Photographs of strawberries (panel a), cucumbers (panel b), cherry tomatoes (panel c), and banana (panel d) coated with edible films derived from quince and flax with and without probiotic (LGG) as compared with uncoated samples for each.

FIG. 6, panels (a)-(f). Digital images of edible films coated on glass slides (made slightly thick for better observation) for: Quince (panel a), Flax (panel b), Basil (panel c), Quince-B (panel d), Flax-B (panel e), and Basil-B (panel f).

FIG. 7. TGA thermograms of edible films (Quince, Flax, Basil, Quince-B, Flax-B, and Basil-B) with and without probiotics at a rate of 10° C./min.

FIG. 8. UV-vis spectra for all samples (Quince, Flax, Basil, Quince-B, Flax-B, and Basil-B) within the wavelength range of 200-800 nm.

FIG. 9, panels (a)-(f). SEM images and elemental mapping of the cross-section of edible films derived from: Quince (panel a), Flax (panel b), Basil (panel c), Quince-B (panel d), Flax-B (panel e), and Basil-B (panel f). The red and green dots represent the presence and dispersion of C and O, respectively. In the samples with LGG, in addition to C and O, the blue and purple dots represent the presence of N and P, respectively, which belong to amino acids of probiotics.

### DETAILED DESCRIPTION OF THE INVENTION

In a first aspect, the present disclosure is directed to a novel edible film that both preserves and adds nutritive value to produce, such as fruits and vegetables. The edible film includes at least the following two components: (i) dried (dehydrated) mucilage and (ii) a probiotic dispersed in the dried mucilage. In some embodiments, the edible film includes only the foregoing two components. In other embodiments, the edible film may include one or more other components, such as a plasticizer (e.g., glycerol), food color, flavoring agent, sweetener, natural wetting agent, and/or fragrance (e.g., an essential oil). In some embodiments, any one or more of the foregoing additional components are excluded from the edible film. The film is primarily intended to be edible and non-toxic to humans although other mammals (or non-mammals) could benefit.

The term “dried mucilage” or “dehydrated mucilage,” as used herein, refers to mucilage that is at least partially removed of water compared to its natural state. As further discussed later in this disclosure, the dried mucilage can be obtained by drying (i.e., dehydrating) mucilage obtained from plant material. The source of the dried mucilage may be, for example, seeds, leaves, middle lamella, fruit, bark, or root of a plant. In particular embodiments, the dried mucilage is obtained from seeds. Some particular examples of seeds from which mucilage can be obtained include quince seed, flax seed, basil seed, or combination thereof. Other types of seeds from which mucilage can be obtained include chia seeds, radish seeds, wild sage seeds, mustard seeds, arugula seeds, cress seeds, natto soybeans, and fenugreek seeds. In particular embodiments, the mucilage is obtained from quince seeds. Some examples of leaves from which mucilage can be obtained include aloe, cacti, gooseberry, hibiscus, mallow, and purslane leaves. Some examples of fruit from which mucilage can be obtained include okra, gooseberries, and plantain. An example of bark from which mucilage can be obtained is slippery elm inner bark. Some examples of roots from which mucilage can be obtained include cassava root, wheat (Triticum aestivum) root, burdock root, mallow root, and cowpea root.

Mucilage, a branch of plant hydrocolloid with a hydrophilic nature, creates a gel-like aqueous solution. Mucilage can be derived from various parts of the plants such as seeds, leaves, middle lamella, barks, and root (Beikzadeh et al., Advances in Colloid and Interface Science, 280, 102164, 2020). Mucilages are natural blends of several polysaccharide structures and have higher swelling ability compared to polysaccharides already used in pharmaceutical applications, such as guar gum, arabinoxylan, rhamnogalatouronan, and galactomannans (Hussain et al., Functional Biopolymers, pp. 127-148, Springer International Publishing. https://doi.org/10.1007/978-3-319-95990-O_19, 2019). Mucilage provides enhanced barrier properties in environments with low relative humidity and produce slimy masses that take longer to dissolve than currently available natural gums. Quince seed mucilage is composed of glucuronoxylan which is a natural blend of glucuronic acid and xylose (Hussain et al., Ibid. 2019). Flaxseed mucilage is a mixture of rhamnogalacturonan I and arabinoxylan (Naran et al., Plant Physiology, 148(1), 132-141, https://doi.org/10.1104/pp. 108.1235132008). Basil seed mucilage is a combination of xylose, arabinose, rhamnose, and galacturonic acid (Samateh et al., Scientific Reports, 8(1), 7315 (1-8)2018).

Notably, as used herein, the term “mucilage” does not include gums. Gums are compositionally and texturally distinct from mucilage. Mucilages are natural blends of several polysaccharide (and exopolysaccharide) structures, with proteins or glycoproteins often also present, and have higher swelling ability as well as mixed properties of the polysaccharides compared to single structure polysaccharides, such as gums.

The probiotic can be any of the probiotic species known in the art permissible for human consumption. According to the Food and Agriculture Organization of the United Nations (FAO) and the World Health Organization (WHO), probiotics are living microorganisms giving benefits out to the host once they reach sufficient numbers (Hemarajata & Versalovic, Therapeutic Advances in Gastroenterology, 6(1), 39-51, 2013). In particular embodiments, the probiotics that may be included in the edible film include lactic acid bacteria (LAB), which may be rod-shaped or spherical. Some examples of lactic acid bacteria include the following genera: Lactobacillus, Leuconostoc, Lactococcus, Streptococcus, Bifidobacterium, and Pediococcus, any species of which may be included in the edible film. In particular embodiments, the probiotic includes one or more species of the genus Lactobacillus. Some examples of species of Lactobacillus that may be included in the edible film include Lactobacillus rhamnosus, Lactobacillus plantarum, Lactobacillus acidophilus, Lactobacillus reuteri, Lactobacillus delbrueckii, Lactobacillus brevis, Lactobacillus paraplantarum, Lactobacillus casei, Lactobacillus paracasei, Lactobacillus coryniformis, Lactobacillus helveticus, and Lactobacillus kefiranofaciens, any one or more which may be included in the edible film. Other probiotic species that may be included in the edible include, for example, Leuconostoc mesenteroides, Bacillus coagulans, Saccharomyces boulardii, Pediococcus pentosaceus, Leuconostoc citreum, Leuconostoc argentinum, Bifidobacterium bifidum. Streptococcus thermophilus, Lactococcus lactis, Acetobacter pasteurianus, and Acetobacter aceti. In some embodiments, a combination of precisely or at least one, two, thme, or more of any of the foregoing genera and/or species of probiotic is included in the edible film. In other embodiments, one or more of any of the foregoing genera and/or species of probiotic is excluded from the edible film.

In some embodiments, the edible film further includes a plasticizer. The plasticizer is typically a polyol, such as a diol, triol, tetrol, or higher polyol (e.g., precisely or at least five or six hydroxy groups). The plasticizer is typically non-polymeric and typically has a molecular weight of at least 150 or 200 g/mol and up to 250, 300, 350, 400, 450, or 500 g/mol. For purposes of the present invention, the polyol should be non-toxic. An example of a non-toxic diol plasticizer is propylene glycol. An example of a non-toxic triol plasticizer is glycerol. Some examples of non-toxic tetrol plasticizers include erythritol and pentaerythritol. Some examples of non-toxic higher polyol plasticizers include sorbitol, xylitol, mannitol, galactitol, inositol, maltitol, lactitol, glucose, fructose, galactose, and sucrose. In some embodiments, any one or more of the foregoing plasticizers is excluded from the edible film.

In particular embodiments, the edible film includes Lactobacillus or one or more particular species thereof, such as Lactobacillus rhamnosus, as the probiotic. In some embodiments, the edible film includes dried mucilage obtained from seeds, such as quince seed, flax seed, basil seed, or combination thereof, or more particularly quince seed, in combination with a Lactobacillus (or more particularly, Lactobacillus rhanmosus) probiotic. In some embodiments, the edible film further includes a plasticizer, such as glycerol. In some embodiments, the edible film includes dried mucilage obtained from seeds, such as quince seed, flax seed, basil seed, or combination thereof, or more particularly quince seed, in combination with a Lactobacillus (or more particularly, Lactobacillus rhamnosus) probiotic, and further includes a plasticizer, such as glycerol.

In some embodiments, the edible film may include a prebiotic. As well known, prebiotics are non-digestible fibrous substances that promote growth of beneficial microorganisms in the gastrointestinal tract. Prebiotics are typically oligosaccharides, such as fructans and galactans. Some examples of fructans include fructooligosaccharides (FOS) and inulins. An example of a galactan is galactooligosaccharides. The prebiotic may alternatively be a resistant starch. Some other examples of prebiotics include xylooligosaccharides, pectin, and beta-glucans. In some embodiments, any one or more of the foregoing prebiotics or all prebiotics are excluded from the edible film.

The edible film, such any of those described above, preferably has a tensile strength of at least 5 MPa and up to 20 MPa. In different embodiments, the edible film has a tensile strength of precisely or at least 5, 8, 10, 12, 15, 18, or 20 MPa, or a tensile strength within a range bounded by any two of the foregoing values (e.g., 5-20 MPa, 10-20 MPa, 12-15 MPa, 15-20 MPa, or 18-20 MPa).

The edible film, such any of those described above, preferably has an elastic modulus of at least 200 MPa and up to 500 MPa. In different embodiments, the edible film has an elastic modulus of precisely or at least 200, 250, 300, 350, 400, 450, or 500 MPa, or an elastic modulus within a range bounded by any two of the foregoing values (e.g., 200-500 MPa, 250-500 MPa, 300-500 MPa, 350-500 MPa, 400-500 MPa, or 450-500 MPa).

The edible film, such any of those described above, preferably has an elongation at break of at least 30% and up to 60%. In different embodiments, the edible film has an elongation at break of precisely or at least 30, 35, 40, 45, 50, 55, or 60%, or an elongation at break within a range bounded by any two of the foregoing values (e.g., 30-60%, 35-60%, 40-60%, 45-60%, or 50-60%).

The edible film, such any of those described above, preferably has a thickness of at least 50 microns and up to 150 microns. In different embodiments, the edible film has a thickness of 50, 60, 70, 80, 90, 100, 110, 120, 130, 140, or 150 microns, or a thickness within a range bounded by any two of the foregoing values (e.g., 50-150 microns, 60-150 microns, 70-150 microns, 80-150 microns, 90-150 microns, 100-150 microns, 50-130 microns, 60-130 microns, 70-130 microns, 80-130 microns, 90-130 microns, 100-130 microns, 50-100 microns, 60-100 microns, 70-100 microns, or 80-100 microns).

The edible film, such any of those described above, preferably has a moisture content of at least or greater than 90%. In different embodiments, the edible film has a moisture content of precisely, at least, or greater than 90%, 91%, 92%, 93%, 94%, or 95%, or a moisture content within a range bounded by any two of the foregoing values (e.g., 90-95%, 91-95%, 92-95%, or 93-95%).

The edible film, such any of those described above, preferably has a water activity at or below 0.6. In different embodiments, the edible film has a water activity at or below 0.6, 0.55, 0.5, 0.45, 0.4, 0.35, or 0.3, or a water activity within a range bounded by any two of the foregoing values (e.g., 0.3-0.6, 0.3-0.55, 0.3-0.5, or 0.3-0.45).

The edible film preferably exhibits a probiotic viability of at least 4.0 log CFU/g after 21 days at room temperature. In different embodiments, the edible film has a probiotic viability of at least 4.0 log CFU/g, 4.5 log CFU/g, 5.0 log CFU/g, 5.5 log CFU/g, 6.0 log CFU/g, 6.5 log CFU/g, 7.0 log CFU/g, or 7.5 log CFU/g, or a probiotic viability within a range bounded by any two of the foregoing values (e.g., 4.0-7.5 log CFU/g, 5.0-7.5 log CFU/g, 6.0-7.5 log CFU/g, 6.5-7.5 log CFU/g, or 7.0-7.5 log CFU/g).

The edible film, such any of those described above, preferably possesses a water vapor permeability (WVP) of no more than or less than 40×10⁻⁸ g/h·m·Pa after 14 days, 21, days, or 28 days. In different embodiments, the edible film possesses a WVP of no more than or less than 40×10⁻⁸ g/h·m·Pa after 14 days, 35×10⁻⁸ g/h·m·Pa after 14 days, or 30×10⁻⁸ g/h·m·Pa after 14 days, 21, days, or 28 days.

In some embodiments, the edible film, such any of those described above, possesses a combination of any one or more specific values or ranges of the tensile strengths, elastic moduli, elongation at break, thicknesses, moisture contents, water activities, probiotic viability, and WVP values provided above. For example, in some embodiments, the edible film has a tensile strength of 10-20 MPa, an elastic modulus of 300-500 MPa, a thickness of 100-130 microns, a moisture content of greater than 90%, a water activity below 0.6, a water vapor permeability (WVP) of no more than 40×10⁻⁸ g/h·m·Pa after 14 days, and exhibits a probiotic viability of at least 7.0 log CFU/g after 21 days at room temperature.

In some embodiments, the edible film has a probiotic concentration of at least 10⁷, 10⁸, 10⁹, or 10¹⁰ CFU/ml, or a probiotic concentration within a range bounded by any two of these values, e.g., 10⁷-10¹⁰ CFU/ml, 10⁸-10¹⁰ CFU/ml, 10⁹-10¹⁰ CFU/ml, 10⁷-10⁹ CFU/ml, or 10⁸-10⁹ CFU/ml. In some embodiments, the probiotic-containing mucilage solution, used in making the edible film, independently has any of the above probiotic concentrations, which may be the same or higher than the probiotic concentration in the final edible film.

In another aspect, the present disclosure is directed to a method for producing any of the edible film compositions described above. The method includes precisely or at least the following steps: (i) obtaining a mucilage aqueous solution; (ii) adding a probiotic to the warmed mucilage aqueous solution at a temperature of 30-50° C. to generate a probiotic-containing mucilage solution; (iii) mixing the probiotic-containing mucilage solution; (iv) forming a film of the probiotic-containing mucilage solution on a non-stick surface; and (v) drying the film of probiotic-containing mucilage solution (optionally, under vacuum) to produce the edible film.

Step (i) of obtaining the mucilage aqueous solution typically includes at least the process of extracting mucilage from mucilage-containing plant material into water or an aqueous solution and separating the plant material from the extracted mucilage. The extraction and/or separation process may be conducted at an elevated temperature (e.g., at least 30, 40, 50, 60, 70, 80, 90, or 100° C., or temperature range therein). In some embodiments, the mucilage-containing plant material is washed or sterilized before undergoing mucilage extraction and separation. In more specific embodiments, step (i) entails the following steps for obtaining the mucilage aqueous solution: (a) washing mucilage-containing plant material; (b) soaking and stirring the mucilage-containing plant material in water at a temperature of 70-90° C. (or 75-90° C., 80-90° C., 85-90° C., 75-85° C., 80-85° C., or 70-80° C.) until a viscous gel-like suspension forms in which mucilage from the plant material is extracted from the plant material into the water, and (c) subjecting the viscous gel-like suspension to a separation process in which the plant material is removed from the viscous gel-like suspension to provide the mucilage aqueous solution. The mucilage-containing plant material can be any of those described in detail earlier above, including seeds, leaves, middle lamella, fruit, bark, and root of the mucilage-containing plant material, or more particularly seeds, such as quince seed, flax seed, basil seed, and combinations thereof, or more particularly, quince seed.

In some embodiments, the washing process in step (a) is achieved by washing the mucilage-containing plant material in a food grade organic solvent and evaporating the food grade organic solvent, wherein the food grade organic solvent may be, e.g., ethanol or acetone. Step (a) may also include decanting and/or rinsing the mucilage-containing plant material to remove surface impurities.

In step (b), a water to plant material weight ratio of 1:1-50:1 (or 2:1-50:1, 5:1-50:1, 10:1-50:1, 2:1-40:1, 5:1-40:1, 10:1-40:1, 2:1-30:1, 5:1-30:1, 10:1-30:1, 15:1-30:1, or 20:1-30:1 weight ratio, or precisely or about 25:1 weight ratio) may be used. In some embodiments, during or after step (b) and before step (c), the viscous gel-like suspension is lowered in temperature (e.g., to 30-60° C. or 40-50° C.), which increases its viscosity, before being subjected to the separation process in step (c).

In some embodiments, the separation process in step (c) comprises a filtration process and/or centrifugation process. In the filtration process, the viscous gel-like suspension is filtered through a filter typically having a mesh size of 100-300 microns, or more preferably about 250 microns. The filter may be, for example, a nylon mesh filter.

The filtration may be conducted while the viscous gel-like suspension is at any of the elevated temperatures provided above (e.g., to 30-60° C. or 40-50° C.) or at room temperature (typically, 18-25° C.). In the centrifugation process, the viscous gel-like suspension is typically centrifuged at a g-force of at least or greater than 4000×g (about 6000 rpm). In other embodiments, the viscous gel-like suspension is centrifuged at a g-force of at least or greater than 5000×g (about 6700 rpm), 6000×g (about 7300 rpm), 7000×g (about 7900 rpm), 8000×g (about 8450 rpm), or 10,000×g (about 9450 rpm), or a g-force or rpm within a range bounded by any two of the foregoing values. Notably, the foregoing conversions are based on a rotor radius of about 100 mm, but may be adjusted based on other rotor sizes, such as 50 mm or 150 mm. In some embodiments, filtration and centrifugation are used in combination, i.e., sequentially, either with filtration followed by centrifugation or centrifugation followed by filtration.

In some embodiments, the method of obtaining the mucilage aqueous solution further includes the following step: (d) adding a plasticizer (e.g., glycerol or any other type of plasticizer described earlier above) under stirring condition and optionally elevated temperature condition (e.g., 40-50° C.) to the mucilage aqueous solution. In some embodiments, the method of obtaining the mucilage aqueous solution further includes autoclaving the mucilage aqueous solution, typically at a temperature of 100-150° C. (or more particularly, about 120° C.) for 15-45 minutes (or more particularly, about 30 minutes). The autoclaving process may be performed on mucilage aqueous solution that may or may not include a plasticizer or other additional component.

Step (ii) of adding a probiotic to the mucilage aqueous solution is typically conducted while the mucilage aqueous solution is at an elevated temperature of 30-50° C. In different embodiments, the mucilage aqueous solution is at an elevated temperature of precisely or about 30, 32, 35, 37, 40, 42, 45, 48, or 50° C., or range therein (e.g., 30-40° C. or 32-40° C.) to generate the probiotic-containing mucilage solution. In some embodiments, a plasticizer is added in step (ii) if plasticizer was not incorporated when obtaining the mucilage aqueous solution in step (i). The probiotic may be any one or more of any of the probiotics described in detail earlier above, such as, for example, any of the probiotic Lactobacillus species, such as Lactobacillus rhamnosus.

Step (iii) of mixing the probiotic-containing mucilage solution can employ any of the mixing processes well known in the art. The probiotic-containing mucilage solution may be mixed while the probiotic-containing mucilage solution is at any of the elevated temperatures provided above in step (ii) or at room temperature (typically, 18-25° C.). In some embodiments, a plasticizer is added in step (iii) if plasticizer was not incorporated in step (i) or (ii).

Step (iv) of forming a film of the probiotic-containing mucilage solution onto a non-stick surface can employ any of the methods known in the art of forming a film on a surface of a material. For example, the probiotic-containing mucilage solution may be poured onto, sprayed onto, or brushed or roll-coated onto the surface, or the surface may be dipped into the probiotic-containing mucilage solution. The resulting liquid film may have any of the thicknesses provided earlier above. The film may be formed while the probiotic-containing mucilage solution or surface (or both) is at any of the elevated temperatures provided above in step (ii) or at room temperature (typically, 18-25° C.). The non-stick surface can have any of the non-stick compositions of the art, e.g., polytetrafluoroethylene (FTFE), silicone, ceramic, or stainless steel.

Step (v) of drying the film of probiotic-containing mucilage solution to produce the edible film may be conducted while the film of probiotic-containing mucilage solution is at room temperature or an elevated temperature (e.g., 30, 32, 35, 37, 40, 42, 45, 48, or 50° C.).

In some embodiments, the drying step is performed under vacuum. The term “vacuum,” as used herein is used to indicate “reduced pressure”, i.e., below 1 atm (e.g., up to or less than 0.9, 0.8, 0.7, 0.6, or 0.5 atm). The film is subjected to drying conditions (i.e., optionally under vacuum at elevated or room temperature) for a sufficient period of time to convert the liquid film into a pliable solid form having any of the physical properties (e.g., tensile strength, elastic modulus, and/or elongation) described earlier above. Depending on the temperature, the period of time may be, for example, 6, 12, 18, 24, 30, 36, 42, 48, 54, 60, 66, or 72 hours, or a time period within a range bounded by any two of the foregoing values (e.g., 24-72 hours). In more specific embodiments, the film of probiotic-containing mucilage solution is dried (optionally, under vacuum) at a temperature of 25-40° C. (or more particularly, precisely or about 37° C.) for a period of time of 24-72 hours, 30-60 hours, or 40-50 hours (or precisely or about 48 hours). In some embodiments, the edible film has a final probiotic concentration of 10⁸-10⁹ CFU/ml. The edible film is then removed from the non-stick surface, such as by peeling. Once removed from the surface, the edible film can be used to wrap or coat produce, such as by placing or pressing the edible film onto produce, which may also include warming the edible film while it is in contact with the produce in order for the edible film to soften and completely coat the produce.

In any of the above described embodiments of making the edible film, the mucilage may be obtained from, for example, seeds, leaves, middle lamella, fruit, bark, or root of a plant. In particular embodiments of making the edible film, the mucilage is obtained from seeds, such as quince seed, flax seed, basil seed, or combination thereof. In particular embodiments of making the edible film, the probiotic is or includes Lactobacillus, or more particularly, Lactobacillus rhamnosus. In some embodiments of making the edible film, the mucilage is obtained from seeds, such as quince seed, flax seed, basil seed, or combination thereof, or more particularly quince seed, and the probiotic is or includes a Lactobacillus, or more particularly, Lactobacillus rhamnosus. In some embodiments of making the edible film, the method incorporates a plasticizer, such as glycerol, into the mucilage aqueous solution. In some embodiments of making the edible film, the mucilage is obtained from seeds, such as quince seed, flax seed, basil seed, or combination thereof, or more particularly quince seed, and the probiotic is or includes a Lactobacillus, or more particularly, Lactobacillus rhamnosus, and a plasticizer, such as glycerol, is incorporated into the mucilage aqueous solution.

Any of the edible films produced by any of the above described methods preferably has a tensile strength of 5-20 MPa, or more preferably 10-20 MPa. Any of the edible films produced by any of the above described methods preferably has an elastic modulus of 200-500 MPa, or more preferably 300-500 MPa. Any of the edible films produced by any of the above described methods preferably has an elongation at break of 30-60%, or more preferably 35-60% or 40-60%. Any of the edible films produced by any of the above described methods preferably has a thickness of 50-150 microns, or more preferably 100-130 microns. Any of the edible films produced by any of the above described methods preferably has a moisture content of greater than 90%, 92%, 93%, 94%, or 95%. Any of the edible films produced by any of the above described methods preferably has a water activity below 0.6 or 0.5. Any of the edible films produced by any of the above described methods preferably exhibits a probiotic viability of at least 7.0 log CFU/g after 21 days at room temperature. Any of the edible films produced by any of the above described methods preferably possesses a water vapor permeability (WVP) of no more than 40×10⁻⁸ g/h·m·Pa after 14 days. In some embodiments, any of the edible films produced by any of the above described methods possesses a combination of any one or more of the tensile strengths, elastic moduli, elongation at break, thicknesses, moisture contents, water activities, probiotic viability, and WVP values provided above.

In another aspect, the present disclosure is directed to a method for extending the lifetime and increasing the nutritive value of a fruit or vegetable. The method includes the steps of: (i) coating a piece of produce (e.g., fruit or vegetable) with a probiotic-containing mucilage solution, as described above; and (ii) drying the coating to produce an edible film containing dried mucilage and the probiotic dispersed in the dried mucilage. The probiotic-containing mucilage solution may be coated onto the produce by any suitable means, e.g., dipping or spraying. Some examples of fruits that may be coated with the edible film include strawberries, bananas, blueberries, raspberries, peaches, pears, tomatoes, oranges, grapefruit, plums, apples, apricots, lemons, limes, watermelon, and kiwis. Some examples of vegetables that may be coated with the edible film include cucumbers, carrots, zucchini, celery, potatoes, broccoli, onions, garlic, bell peppers, beets, brussel sprouts, squash, cauliflower, parsnips, mushrooms, and peas.

The fruit or vegetable may be coated with any of the edible films described earlier, including any of the exemplary embodiments and combinations thereof, as described above. In any of the above described embodiments of coating a fruit or vegetable with an edible film, the mucilage in the edible film may be obtained from, for example, seeds, leaves, middle lamella, fruit, bark, or root of a plant. In particular embodiments of coating a fruit or vegetable with an edible film, the mucilage is obtained from seeds, such as quince seed, flax seed, basil seed, or combination thereof. In particular embodiments of coating a fruit or vegetable with an edible film, the probiotic is or includes Lactobacillus, or more particularly, Lactobacillus rhamnosus. In some embodiments of coating a fruit or vegetable with an edible film, the mucilage is obtained from seeds, such as quince seed, flax seed, basil seed, or combination thereof, or more particularly quince seed, and the probiotic is or includes a Lactobacillus, or more particularly, Lactobacillus rhamnosus. In some embodiments of coating a fruit or vegetable with an edible film, the edible film includes a plasticizer, such as glycerol. In some embodiments of coating a fruit or vegetable with an edible film, the mucilage is obtained from seeds, such as quince seed, flax seed, basil seed, or combination thereof, or more particularly quince seed, and the probiotic is or includes a Lactobacillus, or more particularly, Lactobacillus rhamnosus, and a plasticizer, such as glycerol, is also incorporated into the mucilage aqueous solution.

The fruit or vegetable is coated with an edible film preferably having a tensile strength of 5-20 MPa, or more preferably 10-20 MPa. The fruit or vegetable is coated with an edible film preferably having an elastic modulus of 200-500 MPa, or more preferably 300-500 MPa. The fruit or vegetable is coated with an edible film preferably having an elongation at break of 30-60%, or more preferably 35-60% or 40-60%. The fruit or vegetable is coated with an edible film preferably having a thickness of 50-150 microns, or more preferably 100-130 microns. The fruit or vegetable is coated with an edible film preferably having a moisture content of greater than 90%, 92%, 93%, 94%, or 95%. The fruit or vegetable is coated with an edible film preferably having a water activity below 0.6 or 0.5. The fruit or vegetable is coated with an edible film preferably having a probiotic viability of at least 7.0 log CFU/g after 21 days at room temperature. The fruit or vegetable is coated with an edible film preferably possessing a water vapor permeability (WVP) of no more than 40×10⁻⁸ g/h·m·Pa after 14 days. In some embodiments, the fruit or vegetable is coated with an edible film possessing a combination of any one or more of the tensile strengths, elastic moduli, elongation at break, thicknesses, moisture contents, water activities, probiotic viability, and WVP values provided above. The edible film on the fruit or vegetable having any one or more the above properties may have any of the compositions described earlier above and may be produced by any of the methods described earlier above.

Examples have been set forth below for the purpose of illustration and to describe the best mode of the invention at the present time. However, the scope of this invention is not to be in any way limited by the examples set forth herein.

### EXAMPLES

### Overview

The aim of the following experiments was to prepare eco-friendly edible films capable of extending the shelf life of produce while providing additional nutritive value.

Seed mucilages of quince, flax, and basil were particularly studied. The mucilages are natural and compatible blends of different polysaccharides that have been shown to have medical benefits. All three seed mucilage films exhibited high moisture retention regardless of the presence of probiotics, which is expected to help preserve the moisture/freshness of food. Films from flax and quince mucilage were found to be more thermally stable and mechanically robust with higher elastic moduli and elongation at break than basil mucilage films. These films effectively protected fruits against UV light, maintaining the probiotics viability and inactivation rate during the storage period. The fruits and vegetables, coated by the mucilage-based films, retained their freshness longer when compared with the uncoated ones. According to the overall results, quince-based probiotic film showed the best mechanical, physical, morphological and bacterial viability among the other samples, showing the promising potential of sustainable production of 100% natural probiotic edible coatings with enhanced barrier properties for food preservation applications.

Throughout the past decade, the human microbiome has received increasing attention in both the medical and scientific community as well as the general public. As well known, the microbiome consists of the bionetwork of commensal, symbiotic, and pathogenic microorganisms residing in the body. The number of bacteria inhabiting the human body is known to be an order of magnitude more than human cells, the majority of which are primarily found in the gastrointestinal tract. Gut microbiota play an important role in protecting against invading pathogens and the regulation of various physiological functions such as metabolism, development, and stability of the immune and nervous system which, overall, results in prevention of inflammation and reduction in risks to conditions and diseases such as diarrhea, allergies, obesity, and cancer. Throughout an individual's lifetime, the gut microbiota varies depending on diet, lifestyle, and environmental conditions such as increasing sterile food consumption, hygiene, stress, and antibiotic administration.

As well known, probiotics are living microorganisms providing benefits to the host once they reach to sufficient numbers. While there is no uniform therapeutic dosing recommendation for probiotic intake, the United States Food and Drug Administration recommends the minimum concentration of 106 CFU (Colony Forming Units) per mL or gram of probiotic viable cells at consumption in the food product (Haffner et al., AIMS Materials Science, 3(1), 114-136, 2016). Currently, there are a variety of probiotic dairy products, such as fermented milk and yogurt. To expand the probiotic application and also to cater dietary restrictions, many non-dairy novelties have also been introduced, such as probiotic juices and cereals. However, research on probiotic encapsulation methods of non-dairy products, such as raw fruits and vegetables, is limited. The gap may be the result of the overall challenges affecting cell viability. Successful probiotic encapsulation requires consideration of important properties for probiotic viability, including resistance to gastric acidity, storage temperatures, effects of competitive bacteria, and consistency in air and water exposure.

Mucilage, a branch of plant hydrocolloid with a hydrophilic nature, is able to produce a gel-like aqueous solution. Mucilage can be derived from various parts of the plants such as seeds, leaves, middle lamella, barks, and root (Beikzadeh et al., Advances in Colloid and Interface Science, 280, 102164, 2020). Mucilages are natural blends of several polysaccharide structures and have higher swelling ability compared to polysaccharides already used in the pharmaceutical applications such as guar gum, arabinoxylan, rhamnogalatouronan, and galactomannans (Hussain et al., Functional Biopolymers, pp. 127-148, Springer International Publishing. https://doi.org/10.1007/978-3-319-95990-0_192019). Aside from their preservation ability, these mucilage-based films are advantageously non-toxic, biocompatible, and can serve as barriers to the transportation of moisture, oxygen, and aromas.

### Materials

Flax (L. usitatissimum) seeds and Basil (O. basilicum) seeds were purchased from a local market in Ithaca, New York. Quince (C. oblonga) seeds were purchased from a company in California, USA. Glycerol (G9012, ≥99.5%) and diiodomethane (DIM, ≥98%) were commercially obtained. Ethanol (200 proof pure, food-grade) was commercially obtained. Ultrapure water was used in all steps mentioned and was purified using a Milli-Q (MQ) water purification system. Phosphate buffer saline (PBS) 100 mL tablets was commercially obtained. Agar was commercially obtained. The bacterial strain Lactobacillus rhamnosus GG (LGG) was obtained from Chr Hansen probiotics collection (Denmark). This probiotic is Gram-positive, rod-shaped, facultative, anaerobic, heterofermentative, lactic acid bacteria, and shows optimal growth at 37° C.

### Film Preparation

Flax and Quince mucilage preparation: Each seed type was sieved and washed in 100 mL ethanol and stirred for 5 min and decanted to remove surface impurities. Then, any remaining ethanol was allowed to evaporate and the seeds were then dried at 45° C. in an oven overnight. The clean, dry seeds were then presoaked in MQ water for 20 min with a water to seed weight ratio of 25:1 (Davachi & Shekarabi, International Journal of Biological Macromolecules, 113, 66-72, 2018). The solution was heated to 80° C. for 20 min during the mucilage extraction to kill potential pathogens. Once the viscosity of the solutions increased, the temperature was lowered to 45° C. and stirring continued for another 5-10 min until a viscous gel-like solution formed. Next, to separate the mucilage from the seeds, the viscous solution was passed through a nylon mesh filter 255 μm at a temperature of around 45° C. Once gels were obtained, under constant stirring (750 rpm), glycerol (5 wt %) was added to the solutions as a plasticizer at 45° C. for 15 min. To remove the remaining solid contaminants, the glycerol-gel solutions were poured into Falcone tubes and centrifuged for 15 min at 5500×g (˜7000 rpm). Finally, the mucilages were autoclaved at 120° C. for 30 min. The initial weight of seed used for flax and quince mucilage preparation were 18 g and 8 g, respectively.

Basil mucilage preparation: 10 g of basil seeds were treated as above until a viscose gel-like solution was formed. Then, the solution was poured the into Falcone tubes, kept at −80° C. freezer overnight, and then freeze-dried for 72 hr to obtain dried powders. In order to separate the seeds from the mucilage powders, a laboratory sieve where the freeze-dried powders were rubbed against the sieve. To the mucilage powder, MQ water at 80° C. was added with water to seed weight ratio of 25:1 and once the viscosity of the solution increased, heating was stopped and stirring continued for another 5-10 min to form a gel with a high viscosity. Then, similar to previous samples, 5 wt % glycerol was added to the solution under constant stirring of 750 rpm at 45° C. for 15 min. To separate the mucilage from the seeds, the viscous solution was passed through the nylon mesh filter (255 μm) with a temperature of around 45-50° C. and the solution was poured into test-tubes and centrifuged for 15 min at 5500 xg to remove any remaining contaminations. Finally, the mucilage was autoclaved at 120° C. for 30 min.

Probiotic mucilage preparation: After preparation of the mucilage samples, the solutions were warmed to 37° C. and 0.1 g of the powdered probiotic LGG added and mixed for 10 min to reach the final concentration of 108-10⁹ CFU/mL.

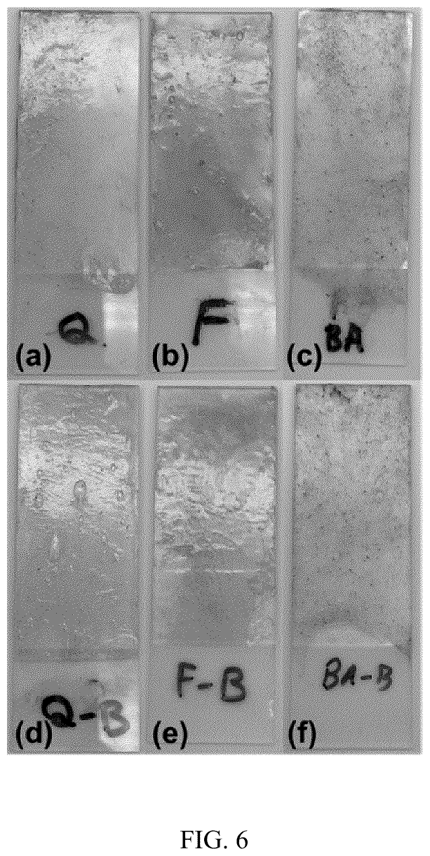

Ediblefilm preparation: To prepare the films, 50 mL of each solution of mucilage, with and without bacteria strain, were poured onto Teflon plates (20×10 cm²) and dried on leveled trays in a vacuum oven at 37° C. for 48 h. The films were removed and stored for further analysis in resealable plastic bags in the freezer at −20° C. to prevent the growth of the bacteria. Before use, the films were kept in the plastic bags until they reached room temperature (25° C.). Non-probiotic films were prepared as a control. The samples without bacteria were named after their seeds (Quince, Flax and Basil) and the samples with bacteria were named with the seed name-B (Quince-B, Flax-B, Basil-B). The digital images of the coated films on the glass slide are shown in FIG. 6.

### Characterization

### Fourier-Transform Infrared-Attenuated Total Reflection Spectroscopy (FTIR-ATR)

The IR spectra of the prepared films obtained using IRAffinity-iS Fourier Transform Infrared Spectroscopy (FTIR) equipped with a Quest@ single reflection attenuated total reflectance (ATR) module, in the frequency range of 400-4000 cm⁻¹ with resolution of 4 cm⁻¹ (averaging 128 scans).

### Moisture Content, Water Solubility and Activity

The moisture content of the films was calculated according to the ASTM D4442 method. Films were dried in an oven at 103±2° C. and their mass change was monitored until a constant weight was obtained.

The water solubility of the films was determined by the ratio of the weighed round-shaped (1×1 cm²) dry films after immersion in 50 mL of MQ water under constant stirring at 25° C. for 5 h. Then, the films were removed and dried at 100±2° C. until no more change in weight was observed (final dry weight). The solubility percentage (triplicates for each film) was measured using Eq. 1 (Davoodi et al., ACS Sustainable Chemistry & Engineering, 8(3), 1487-14962020).

$$\% Solubility = \frac{[ Initial dry weight ] - [ Final dry weight ]}{[ Initial dry weight ]} \times 100 \qquad ( 1 )$$

The water activity of the edible films was conducted using a benchtop water activity meter. Each edible film (1.5×1.5 cm²) was analyzed in triplicate and the average temperature and analysis time per sample were 25° C. and ˜5 min, respectively.

The film thickness was measured using a digital micrometer at three random positions and all the measurements were done in triplicate.

### Water Vapor Permeability

The water vapor permeability (WVP) kinetics of the films was investigated using a modified ASTM E96-95 method (Davachi & Shekarabi, 2018). Prepared films were cut and placed in a vial cell with a diameter of 1.5 cm and a depth of 3 cm. To provide a constant relative humidity (RH) of 52% at 25° C. saturated NaCr₂O₇·2H₂O solution was placed in a desiccator alongside the vial cell. The weight change of the films was measured every 24 h, and the loss in the mass was directly attributed to water evaporation. The results were plotted against time. To calculate WVTR, the slope of this was normalized to the mass transfer surface area (m²) according to (Eq. 2) (Gontard et al., Journal of Food Science, 57(1), 190-195, 1992), where R₁ and R₂ are the RH in the desiccator and the cell, respectively. W is the weight gain of the vial over 24 hr (t), X is the film thickness, A is the mass transfer area, and ΔP is the saturation vapor pressure of water (Pa) at 25° C. (3.173 kPa).

$$W V P = \frac{WVTR}{Δ P ( {R}_{1} - {R}_{2} )} = \frac{( W \times X}{( A \times t \times Δ P )} \qquad ( 2 )$$

### Contact Angle

To evaluate the hydrophobicity of the samples, contact angle measurements were performed using a Ramé-hart instrument by depositing a small drop (50 μL) of MQ water and DIM on films surface. The angle between the film surface was automatically measured via image software provided by the manufacturer. At least three measurements were made, and the average was reported.

### UV-Vis Spectroscopy

To investigate the behavior of the films against UV and visible light, a UV-2600 spectrophotometer equipped with a film holder was used. Tests were performed at wavelengths between 200 and 800 nm. All tests were done in triplicate. The transparency of the films was obtained using Eq. 3 (Jridi et al., International Journal of Biological Macromolecules, 67, 373-379, 2014), where T₆₀₀ is the transmittance at 600 nm and x is the thickness of the film (mm): The greater the transparency value, the opaquer the films.

$$Transparency value = \frac{- log {T}_{600}}{x} \qquad ( 3 )$$

### Color Characteristics

To measure the color of the films, a chromameter was calibrated against a standard white tile and set to D65 illuminant/2° observer angle. Films (˜1 mm thick) were fixed on glass slides against a white background. Reflectance was measured on the film surface, and the results were reported as CIELAB values lightness (L\hat{ }*), redness (+a\hat{ }*) or greenness (−a\hat{ }*), and yellowness (+b\hat{ }*) or blueness (−b\hat{ }*). The chroma (C\hat{ }*), hue angle (h), and total color difference ΔE were calculated according to the following equations (Eq. 4-6) (Yan et al., Food Hydrocolloids, 106414. https://doi.org/10.1016/j.foodhyd.2020.106414, 2020), where ΔL*, Δa*, and Δb* are the luminosity, redness, and yellowness intensity difference from the initial samples without bacteria. At least three measurements were made. The ΔE*<1 means color differences are not detectable to the naked eye. 1<ΔE*<3 is an indication of minor color differences appreciable by naked eye depending of the hue, and values more than 3 shows the obvious change in human eye (Martínez-Cervera et al., LWT—Food Science and Technology, 44(3), 729-736, 2011).

$$h = {tan}^{- 1} ( {b}^{*} / {a}^{*} ) \qquad ( 4 )$$

$${C}^{*} = {( {a}^{* 2} + {b}^{* 2} )}^{1 / 2} \qquad ( 5 )$$

$$Δ {E}^{*} = {( Δ {L}^{{*}^{2}} + Δ {a}^{{*}^{2}} + Δ {b}^{{*}^{2}} )}^{1 / 2} \qquad ( 6 )$$

### Mechanical Properties

To investigate mechanical properties of the films, tensile strength and elongation at break were measured according to ASTM D882 using a TA Instruments DMAQ800 at 24 t 1° C. Three rectangular samples (3×1 cm²) were mounted between the grips and tested at the crosshead speed of 1 N/s until the samples were ruptured. Tensile strength (MPa) and elongation at break are calculated using Eq. 7 and 8, respectively. In these equations F, x, w, L₀ and L were maximum stretching strength (N), film thickness, width of the film, initial length and lengths at rupture, respectively (Davoodi et al., 2020).

$$Tensile Strength ( MPa ) = \frac{F}{x \times w} \qquad ( 7 )$$

$$Elongation at break ( \% ) = \frac{L}{{L}_{0}} \times 100 \qquad ( 8 )$$

### Thermal Properties

To study the thermal properties and stability of the prepared films, differential scanning calorimetry and thermogravimetric analysis were performed. The DSC tests were performed at a heating rate of 10° C./min in N₂ atmosphere and at temperatures ranging from −40 to 275° C. The samples were heated from 25 to 150° C. and then cooled to −40° C., to erase the thermal history of the films. At the final heating stage, the samples were heated from −40 to 275° C. to investigate their thermal properties such as glass transition temperature (T_{g}), crystallization or decomposition temperature (T_{c}), the width of half height crystallization peak (WHH), and the enthalpy of crystallization (ΔH_{c}). The TGA was conducted starting from room temperature to 500° C., at a heating rate of 10° C./min under nitrogen atmosphere.

### Survival of the Probiotics and Inactivation Rate

The viability of LGG incorporated into the films was performed according to the Ebrahimi et al. method (Ebrahimi et al., LWT, 87, 54-60, https://doi.org/10.1016/j.lwt.2017.08.066, 2018). In summary, to release the bacteria, 1 g of the films containing LGG was added to 99 ml of sterile PBS and mixed gently on a shaker by constant agitation for 1 h. The serial dilutions were cultured on MRS agar and incubated at 37° C. for 48 h. Control samples were also prepared by adding the bacteria to the MQ water. The survivability of the bacteria was assessed using the colony count technique, in which the total count of viable bacteria was obtained as colony-forming units per gram (CFU/g). LGG inactivation kinetics upon storage were determined as the logarithmic value of the relative viability (log N/No). The viability data were fitted to a first-order reaction kinetics model as described in Eq. 9, in which No and N, represent the initial number of the viable bacteria and the number of viable bacteria after a specific time of storage (CFU/g), respectively. Storage time in days is represented by, t, and k_{T} is the inactivation rate constant (log CFU/g·day⁻¹) at temperature (T (Soukoulis et al., Food Hydrocolloids, 52, 876-887, 2016).

$$log {N}_{t} = log {N}_{0} - {k}_{T} t \qquad ( 9 )$$

### Laser Scanning Confocal Microscopy

Laser Scanning Confocal Microscopy (LSCM) images were taken to visualize the surface roughness and morphology of the prepared films. Images were taken with a 10× objective in surface profile mode. Post-image processing was conducted using commercial software in which secant curved surface correction with auto-adjusted height range was made.

### Scanning Electron Microscopy

To observe the presence and even dispersion of probiotics in the films, a scanning electron microscope (SEM) was used at an accelerating voltage of 1.0 kV. The SEM samples were coated with a 15 nm layer of Au—Pd via the Denton Desk V sputter coater before the test.

### Statistical Analysis

To conduct the statistical analysis, commercial software was used. Each dataset was analyzed using one-way ANOVA and the data were reported as a mean t standard deviation. In all of the evaluations *p<0.05 were considered statistically significant.

### Results and Discussion

### FTIR-ATR Spectroscopy

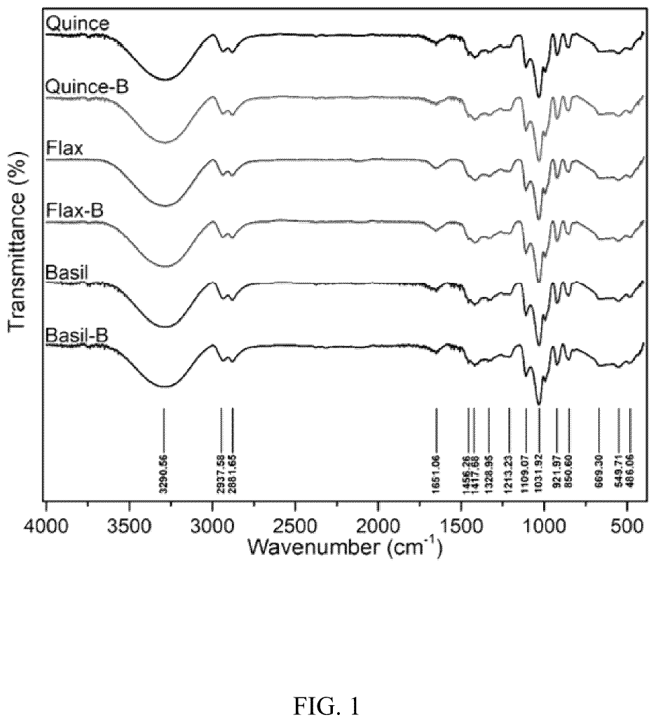

The FTIR-ATR spectra of films, with and without probiotic LGG, after 1 month are depicted in FIG. 1. As shown in FIG. 1, it can be seen that all the films, obtained from different seed mucilages, show similar polysaccharide structure and the presence of bacteria after one month does not spoil and affect the structure of the samples. Since there was no difference between the FTIR results for the films kept in the fridge and room temperature, only the samples stored in the fridge (4° C.) were reported. All samples show characteristic bands between 800-1200 cm-1 in the fingerprint region for polysaccharides or 3,6-anhydro-β-galactose (Davoodi et al., 2020). The bands at 1109 and 1031 cm⁻¹ are attributed to the C—O and —C—O—C glycosidic linkage, respectively. The C—O—O symmetric and asymmetric stretching bands are observed at 1417 and 1651 cm⁻¹, respectively (Saeedi Garakani et al., International Journal of Biological Macromolecules, 143, 533-545, 2020). All the samples exhibited bands at 2937 and 2881 cm-1, which are attributed to the methyl symmetric and asymmetric stretching and bending C—H bond vibrations, while the broad band at ˜3000-3500 cm⁻¹ observed in all the samples is indicative of free OH stretching, glycerol OH bonds, and hydrogen-bonded OH groups (Davoodi et al., 2020).

### Thermal Properties

To investigate the thermal properties and crystallization kinetics of the films, a differential scanning calorimetry (DSC) test was performed. It is generally known that the crystallinity can affect the barrier and physical properties of the films such as WVP, solubility, and UV transmittance. The thermal characteristics of the films are summarized in Table 1 below.

The films demonstrated three peaks, typical of DSC plots for polysaccharides. In the first heating, all the samples show an endothermic peak at around 100° C. which can be attributed to loss of trapped moisture or the water and heat-related phase transitions of the gel structure of the films. To confirm that the observed endothermic peak is related to the water vaporization, samples were cooled down to −50° C., and no exothermic peak (cold crystallization peak) of water was observed. The films show glass transition temperatures between ˜67-74° C. depending on the samples as different mucilages have different composition and structures. As summarized in Table 1, the presence of bacteria has a slight effect on the T_{g}, this confirms that there is no change in the crystalline structure of the mucilage films before the 150° C. upon incorporation of the bacteria.

TABLE 1
Thermal properties of the films with and without probiotic LGG.

| | T_{g} | T_{c} | WHH | ΔH_{c} | Tᵢ | T_{f} |
|---|---|---|---|---|---|---|
| Samples | (° C.) | (° C.) | (° C.) | (J/g) | (° C.) | (° C.) |
| Quince | 73.82 | 187.23 | 35.82 | 49.60 | 192.10 | 366.56 |
| Flax | 67.83 | 208.31 | 56.71 | 56.71 | 211.57 | 347.01 |
| Basil | 71.92 | 173.70 | 33.64 | 47.01 | 175.55 | 352.53 |
| Quince-B | 74.14 | 203.69 | 23.59 | 37.79 | 210.46 | 382.72 |
| Flax-B | 68.05 | 219.67 | 53.84 | 44.02 | 220.49 | 369.93 |
| Basil-B | 72.31 | 175.62 | 31.01 | 22.83 | 185.11 | 356.57 |

All the samples demonstrated an endothermic third peak at ˜173-220° C. which is attributed to the sample decomposition (T_{c}) and combustion initiation at which, glycosidic bonds are cleaved. These films show thermoset-like behavior by having a decomposition peak and leaving char in the DSC pans. It can be hypothesized that heating the bacteria-containing mucilages can kill the bacteria and the available proteins and lipids might be released into the mucilage. It is known that gram-positive bacteria contain teichoic acids that are associated with the cell membrane. These acids contain 1,3-poly(glycerol phosphate) or ribitol phosphate and carbohydrates linked via phosphodiester bonds. They are also known to contain glycosyl substituents attached to glycolipids. The presence of these proteins and lipids can act as plasticizers and since there are a high concentration of these bacteria, these plasticizers can affect the crystallinity of the films containing the bacteria. It is generally known that addition of a plasticizer weakens the interaction between molecules and reduces the crystallinity of the resulting polymers. According to the results shown in Table 1, the WHH and ΔH_{c} values show a decrease upon the addition of bacteria to all the mucilage films, which can be due to the release of those glycolipids and a change the microstructure of the crystals. The narrower peak widths indicate a decrease in the crystallization rate, however, the increase in the T_{c} of the films after the presence of the bacteria might be due to the fact that these bacteria are negatively charged and can interact with counter ions during the heating process in DSC. It is also known that teichoic acid can form soluble complexes with polysaccharides in the presence of moderate dielectric constant solvents in the pH range of 4.5-8.2, which may indicate that this acid may serve as a complexing agent for hydrophilic molecules.

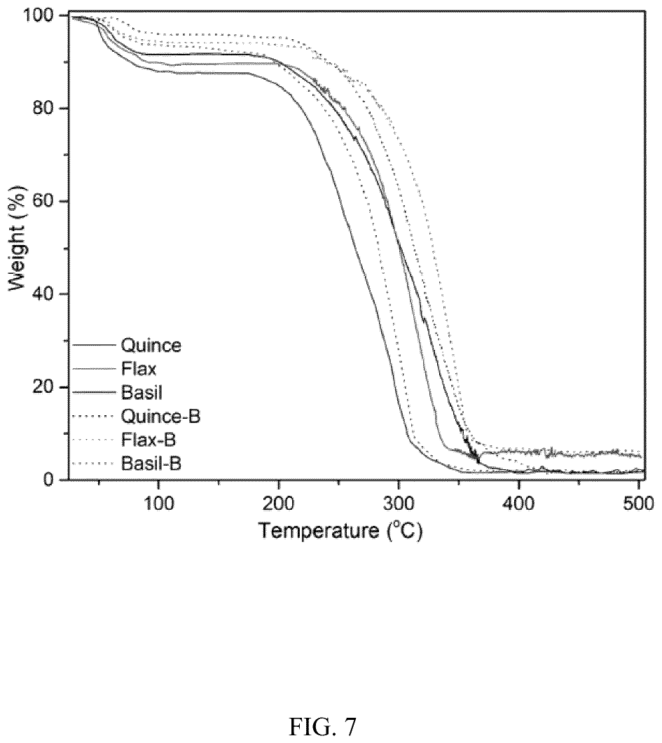

The thermal stability of edible films was measured by TGA in a nitrogen atmosphere to obtain the degradation starting temperature (Tᵢ) and final degradation temperature (T_{f}) (FIG. 7). All the films show two stage degradation, as the first one belongs to the loss of trapped moisture and the second stage belongs to the decomposition of the glycosidic bonds. It can be seen that upon addition of probiotics both Tᵢ and T_{f} have been shifted to the higher temperatures which show that the thermal stability has been increased. Quince based films with and without LGG show higher T_{f} compared to the other two samples which can be due to the occurrence of xylose-uranic acid complexes during the degradation (Alam et al., Comprehensive Materials Processing, pp. 243-260, 2014). The thermal stability is quite obvious in the first stage as well, since the water loss from the films is slower and the weight loss is decreases upon addition of probiotics especially for the Quince-B sample.

The presence of bacteria has decreased the films initial water loss and has increased the films thermal stability. As mentioned earlier, this can be related to the bacterial negative charge and their interaction with counter ions during the heating process. Basil and flax based films show the lowest and highest thermal stability, respectively, although all the films show a similar trend.

### Tensile Properties

Tensile strength and elongation at break, are crucial mechanical characteristics of packaging materials. These results alongside the elastic modulus of the films, in the presence and absence of LGG, are reported in Table 2. Flax films, regardless of the presence of LGG, display increased elasticity with the lowest modulus and highest elongation at break among all the samples. Meanwhile, the basil films show the lowest elongation at break. Interestingly, the quince films show a higher modulus in comparison to flax, however, the tensile strength in flax films is higher. Therefore, out of the three seed mucilage types, quince and flax appear to be more mechanically robust support materials for the edible film applications.

TABLE 2
Mechanical properties of the films
with and without probiotic LGG.

| | Tensile | Elastic Modulus | Elongation at |
|---|---|---|---|
| Samples | Strength (MPa) | (MPa) | Break (%) |
| Quince | 14.61 ± 0.37 ^{b} | 400.63 ± 25.05 ^{a} | 45.54 ± 1.36 ^{b} |
| Flax | 16.46 ± 1.08 ^{a} | 316.23 ± 18.35 ^{b} | 55.68 ± 2.11 ^{a} |
| Basil | 8.53 ± 0.21 ^{c} | 294.90 ± 20.25 ^{c} | 38.31 ± 0.29 ^{c} |
| Quince-B | 14.13 ± 0.27 ^{b} | 422.46 ± 3.81 ^{a} | 43.32 ± 0.46 ^{b} |
| Flax-B | 15.87 ± 0.72 ^{a} | 346.17 ± 14.11 ^{b} | 52.01 ± 1.75 ^{a} |
| Basil-B | 8.04 ± 0.14 ^{d} | 301.63 ± 22.30 ^{c} | 36.11 ± 0.64 ^{d} |

^{a, b, c, d, e} Different letters in the same column indicate significant differences (a > b > c > d; p < 0.05). Values were given as mean ± standard deviation

Upon the addition of LGG to the mucilage films, the tensile strength and elongation at break especially in basil-based films have been deceased since probiotic cells can interrupt the cohesiveness of the polymer chains. The increase in the elastic modulus values for each mucilage after the addition of probiotic LGG is not statistically significant (p<0.05); however, the slight increase might be due to the decrease in molecular mobility and free volume in polymer chains. Glycerol was added as a plasticizer to enhance the mechanical properties of the films by decreasing the intermolecular forces between polymer chains and reducing crystallinity. Upon the addition of probiotic LGG, the glycerol not only acts as a plasticizer but also provides a better environment for probiotics by reducing the osmotic pressure, which makes the films a suitable platform for preservation of the probiotics. The present results indicate that, upon addition of probiotics, the change in mechanical properties is negligible. Only basil-based films showed significant changes. The changes in the basil-based films is most likely due to their inhomogeneity or the presence of seed leftovers.

### Solubility in Water, Moisture Content, and Surface Behavior

Thickness of the films is an important parameter that affects the transparency, water vapor permeability, and mechanical properties of the films. Table 3 summarizes the thickness of the films in the presence and absence of LGG. The results show no difference between the thickness of the samples before and after the addition of LGG, most likely because all films were made with the same amount of solution. In addition, with the same water to seed ratio during the preparation of the films, basil films showed the lowest and flax films showed the highest thickness.

The moisture content after drying is an important factor in edible films because it can affect the viability kinetics during long storage periods and facilitate the melting of these edible films inside the oral cavity. The moisture content of the films is reported in Table 3. The films show similar moisture content across all seed types and the addition of probiotics does not have a significant impact on the film's moisture content (p>0.05). It is noteworthy that the presence of glycerol in all the samples helps maintain the water content and inhibits water evaporation during storage at 4° C. or ambient temperatures, but not at higher temperatures. Moreover, glycerol acts as a humectant providing a suitable environment for the survival of the probiotics.

TABLE 3
Thickness, moisture content, water activity, water solubility and contact angle of the films.

| | | Moisture | Water | Water | | | Surface |
|---|---|---|---|---|---|---|---|
| | Thickness | content | Activity | solubility | θₘ in | θₘ in DIM | Energy |
| Samples | (μm) | (%) | (−) | (%) | MQW (°) | (°) | (mN/m) |
| Quince | 119 ± 1.0 ^{a} | 94.01 ± 1.91 ^{a} | 0.431 ± 0.013 ^{a} | 52.29 ± 1.04 ^{a} | 34.8 ± 5.3 ^{a} | 58.2 ± 1.6 ^{c} | 62.8 ± 2.6 ^{d} |
| Flax | 125 ± 1.0 ^{b} | 94.47 ± 0.04 ^{a} | 0.361 ± 0.009 ^{b} | 75.01 ± 1.92 ^{c} | 26.7 ± 1.6 ^{c} | 92.2 ± 4.3 ^{a} | 95.3 ± 1.8 ^{a} |
| Basil | 115 ± 1.5 ^{c} | 94.08 ± 2.53 ^{a} | 0.332 ± 0.008 ^{c} | 68.69 ± 2.59 ^{b} | 31.1 ± 2.1 ^{c} | 77.6 ± 2.9 ^{b} | 76.4 ± 2.2 ^{c} |
| Quince-B | 120 ± 0.5 ^{a} | 94.55 ± 2.14 ^{a} | 0.435 ± 0.011 ^{a} | 67.13 ± 2.39 ^{b} | 41.6 ± 1.2 ^{a} | 77.7 ± 6.8 ^{b} | 64.9 ± 1,9 ^{d} |
| Flax-B | 126 ± 0.5 ^{b} | 94.09 ± 0.25 ^{a} | 0.363 ± 0.010 ^{b} | 83.18 ± 2.02 ^{e} | 31.7 ± 2.9 ^{e} | 94.7 ± 3.6 ^{a} | 92.6 ± 0.9 ^{b} |
| Basil-B | 116 ± 0.5 ^{c} | 94.64 ± 0.82 ^{a} | 0.334 ± 0.011 ^{c} | 79.16 ± 1.43 ^{d} | 33.9 ± 0.9 ^{b} | 81.2 ± 4.4 ^{b} | 76.3 ± 2.1 ^{e} |

^{a,} ^{b,} ^{c,} ^{d,} ^{e} Different letters in the same column indicate significant differences (a > b > c > d > e; p < 0.05). Values were given as mean ± standard deviation

To address the benefits to food stability, water activity (A_{w}) of the films was measured. A_{w} values close to 1.000 indicate food instability, since the samples can be sensitive to both microbiological (growth of bacteria, yeasts, and mold) and physicochemical changes. However, an A_{w} lower that 0.600 suggests that the films are more stable against microbial growth and will be shelf-stable without any further heat treatment. It can be seen that all the films show low water activity (A_{w}<0.45) and the quince-based films regardless of the presence of bacteria show the highest water activity.

This low water activity inhibits the growth of the bacteria and other microorganisms, while, the addition of glycerol, as mentioned earlier, can protect the water for bacterial survival and prevents the amount of necessary water needed for the survival of the LGG from escaping in the films. The addition of LGG has slightly increased the A_{w}, which is related to the pin-holes created on the surface of the films and changes in the surface integrity.

The high moisture content of the films can represent high water solubility of the films. The water solubility of all the films was measured at pH=7.4, and the results are reported in Table 3. Flax and quince show the highest and lowest solubility, respectively, and upon the addition of LGG the solubility of the films increased. The water solubility can be affected by the polarity of the films, water diffusion, ionization of hydroxyl and carboxyl groups, wettability and surface energy, polymer relaxation, and dissociation of hydrogen and ionic bonds, and the presence of bacteria may change the wettability, surface energy and water diffusion.

The surface behavior of the films was acquired by contact angle measurement with DIM and MQ water, and the results are reported in Table 3. To assess film hydrophilic behavior, the contact angle against MQ water was measured. Quince shows the highest angle, while flax shows the lowest values, which corroborates the water solubility result which indicated more hydrophilicity in flax-based films. Contact angle changes are known to be a function of surface heterogeneity, crystallinity of the polymer, surface energy, and the chemical nature and roughness of the polymer surfaces. Upon addition of probiotics, the contact angle values increased, which could be due to the increase in roughness of the surface caused by the presence of LGG. The hydrophilicity of the samples could have increased upon the addition of LGG; however, it appears that an increase in the roughness is more dominant. The DIM results also confirm more hydrophobic behavior for quince-based films compared with the other samples as they show lower values against this organic solvent.

The surface energy was calculated based on the contact angles. Interestingly, it does not show a similar trend in different samples. The presence of LOG in the films caused a small increase in the surface energy of Quince-B when compared with Quince, which indicates that the presence of bacteria bonds to this film better on the surface. This increase in surface energy can be related to the porous structure caused by the hydrophilic LGG.

The surface energy is decreased in Flax-B, which indicates that LGG weakens the surface bond, although the flax-based films show the highest surface energy regardless of the presence of LGG. Finally, the presence of LGG did not significantly change the surface energy of basil-based films.

### Water Vapor Permeability

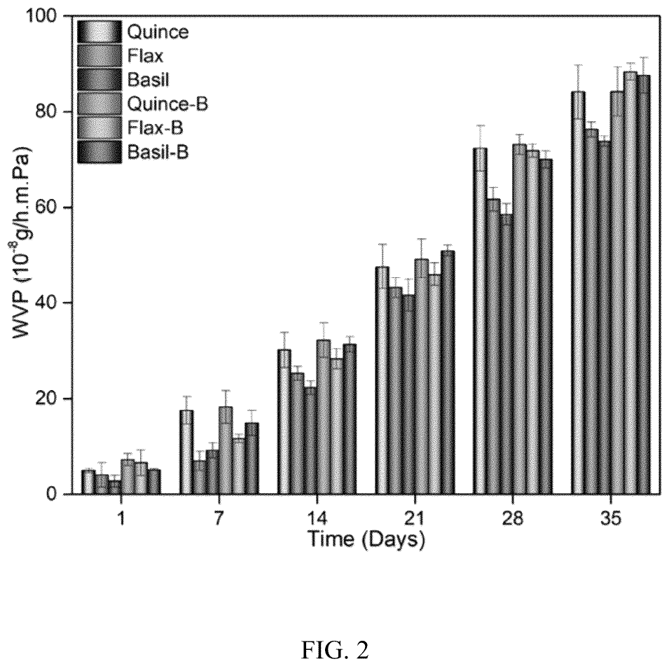

One of the most crucial properties of edible films is water vapor permeability (WVP). WVP can be influenced by the integrity and thickness of the films, and surface behavior, such as hydrophobicity and the degree of crystallinity. In order to maintain the quality of the food, reduction of the moisture transfer between the food and surrounding environment is essential. Hence, WVP should be kept as low as possible. All the films show an increasing WVP over time, due to the water saturation of the films and the easier water transfer between the films and environment. However, as shown in FIG. 2, among the samples without LGG, Basil shows the lowest WVP, while Quince shows the highest value after 5 weeks.

After the addition of LGG, initially, films containing LGG showed the same trend in which the highest and lowest values belong to Quince-B and Basil-B, respectively. Interestingly, initial WVP of the probiotic mucilage films increased by 46, 63, and 85% for Quince-B, Flax-B, and Basil-B samples, respectively, compared with the samples without LOG. The increase in WVP can be attributed to the presence of pin-holes created on the surface of the films and changes in the surface integrity due to the incorporation of the probiotics which result in an increase in the moisture absorption (Ebrahimi et al., 2018). The Flax-B samples show higher values of WVP after 5 weeks, compared to the other samples, which could be due to the thinner films of flax films, which produce a porous structure on the surface of films in the presence of LGG. Quince-based films, however, show similar results regardless of LGG presence, which is attributed to the extracted mucilage which is denser and thicker than the others due to the chemical composition and results in more homogenous films. Moreover, according to the observed solubility results, quince-based samples show lower solubility, further evidence that they maintain their integrity and prevent water evaporation.

### Optical Properties

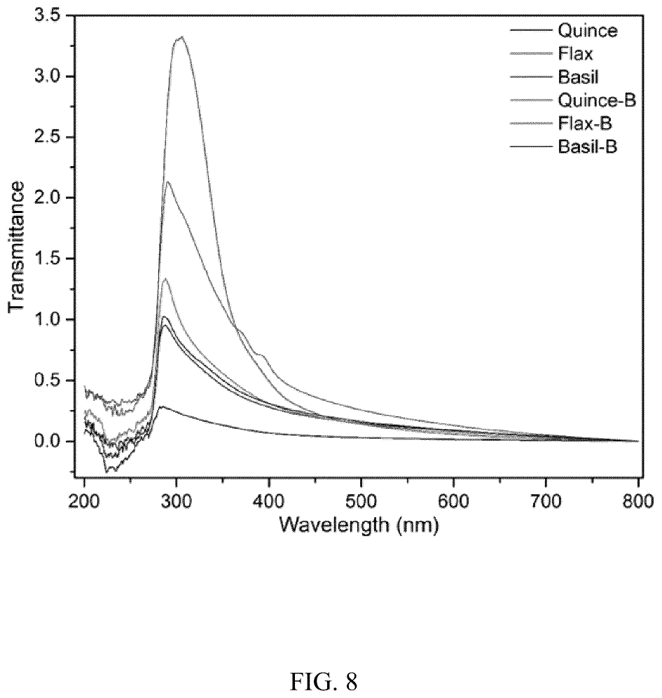

Films with reduced UV transmittance can effectively protect food products from unwanted chemical reactions, especially, UV-induced oxidative degradation which results in discoloration, nutrient loss, and off-flavors. Therefore, suitable optical properties are one of the most important prerequisites in edible films and food packaging applications, particularly since they not only affect consumer preferences but they also maintain the products' quality. There are several important factors that impact the optical properties of the edible films: thickness; crystallinity and mean size of the crystals; plasticizer type and concentration; structural conformation; and compatibility of the film components. The UV and visible light absorbance at selected wavelengths (200-800 nm) were measured, and the results summarized in Table 4, section (a) and FIG. 8. The addition of LGG caused a significant decrease in transparency (higher opacity) of the films compared with the samples without LGG (p<0.05).

TABLE 4
Light absorbance, transparency values, and color characteristics

| | | Wavelength (nm) | | | | | | | | Transparency |
|---|---|---|---|---|---|---|---|---|---|---|
| Films | | 200 | 280 | 350 | 400 | 500 | 600 | 700 | 800 | values |
| (a) | Quince | 0.06 | 0.25 | 0.13 | 0.07 | 0.03 | 0.02 | 0.01 | 0 | 14.44 ± 0.56 ^{a} |
| Light | Flax | 0.42 | 1.26 | 1.36 | 0.50 | 0.14 | 0.06 | 0.02 | 0 | 10.41 ± 0.34 ^{b} |
| Absorbance | Basil | 0.17 | 0.71 | 0.48 | 0.29 | 0.16 | 0.09 | 0.04 | 0.01 | 9.11 ± 0.10 ^{c} |
| | Quince-B | 0.23 | 0.88 | 0.57 | 0.32 | 0.15 | 0.08 | 0.03 | 0 | 9.08 ± 0.27 ^{c} |
| | Flax-B | 0.47 | 1.22 | 1.12 | 0.64 | 0.26 | 0.13 | 0.05 | 0.01 | 7.01 ± 0.05 ^{d} |
| | Basil-B | 0.18 | 0.69 | 0.49 | 0.31 | 0.16 | 0.09 | 0.04 | 0 | 9.06 ± 0.06 ^{c} |

| Films | | L* | a* | b* | C* | H | ΔE* |
|---|---|---|---|---|---|---|---|
| (b) | Quince | 83.69 ± 0.02^{a} | −0.69 ± 0.02^{d} | 13.70 ± 0.04^{e} | 13.72 ± 0.04^{e} | −1.52 ± 0.01^{c} | — |
| Color | Flax | 84.55 ± 0.01^{a} | −2.24 ± 0.01^{f} | 23.48 ± 0.02^{c} | 23.59 ± 0.02^{e} | −1.48 ± 0.01^{e} | — |
| Characteristics | Basil | 70.39 ± 0.02^{b} | 2.86 ± 0.02^{b} | 22.88 ± 0.01^{d} | 23.06 ± 0.01^{c} | 1.45 ± 0.01^{b} | — |
| | Quince-B | 79.11 ± 0.00^{c} | −0.59 ± 0.01^{e} | 22.85 ± 0.02^{d} | 22.86 ± 0.01^{d} | −1.55 ± 0.01^{c} | 10.23 ± 0.01^{b} |
| | Flax-B | 76.13 ± 0.02^{d} | −1.13 ± 0.01^{c} | 36.65 ± 0.00^{a} | 36.66 ± 0.01^{a} | −1.54 ± 0.01^{a} | 15.67 ± 0.02^{a} |
| | Basil-B | 64.56 ± 0.04^{e} | 3.80 ± 0.01^{a} | 31.27 ± 0.03^{b} | 31.50 ± 0.02^{b} | 1.45 ± 0.01^{b} | 10.25 ± 0.01^{b} |

^{a,}^{b,}^{c,}^{d,}^{e,}^{f}Different letters in the same column indicate significant differences (a > b > c > d > e > f, p < 0.05).

Quince shows the highest transparency values regardless of the presence of the LGG, while Basil shows the lowest transparency. Interestingly, the presence of LGG didn't significantly change the transparency values in Basil films. Moreover, all the samples show low transmission in both UV and visible light regions.

The color characteristics of the edible films are reported in Table 4, section (b). Flax and Quince films show higher luminosity (L*), while the Basil has a darker film. It was observed that upon addition of the LGG, the lightness (luminosity) and clearness decreased in all the films. LGG-containing films exhibited higher a* and b* values, which is an indication of more redness and yellowness of the films when compared with the films without LGG. Quince and Flax are greener in color when compared to Basil. The addition of LGG causes the appearance of all the films to become darker with a redder tint which is hard to see by the naked eye. It should be noted that in all the samples, ΔE* values are higher than 3, which is an indication of a visible change; however, the dark shade (chroma) and low hue of the films make the observed changes in color difficult to notice by visual inspection. All the samples maintained stable values of lightness (L*), redness (a*), and yellowness (b*) throughout the storage period (p>0.05, Data not shown).

### Morphology and Topography

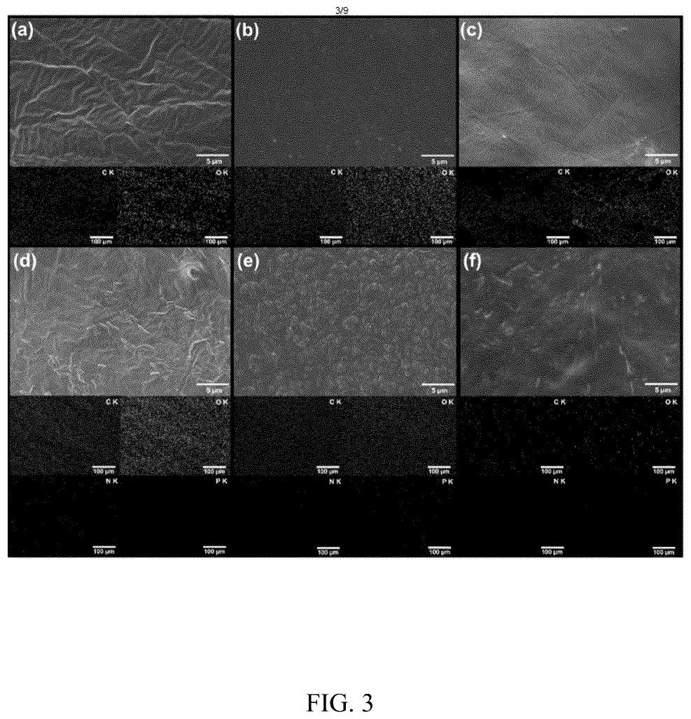

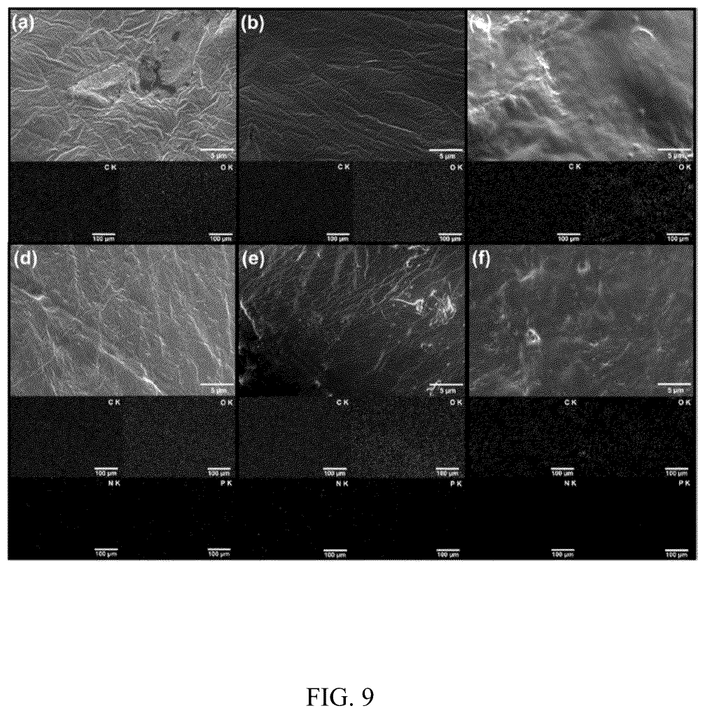

To observe the morphology of the films and confirm the presence and even dispersion of LGG in the probiotic films, SEM images with EDX (energy dispersive X-ray) were taken of the surface (FIG. 3, panels (a)-(f)) and cross-section of the samples (FIG. 9, panels a-f). FIG. 3 shows SEM images and corresponding elemental mapping for quince (panel a), flax (panel b), basil (panel c), quince-B (panel d), flax-b (panel e), and basil-b (panel f). All the samples show a homogenous surface; however, some samples, especially Quince, show wrinkles on the surface, which could be the result of heating the samples (37° C.) to reduce their moisture content during sample preparation for SEM imaging. As mentioned earlier, Quince produces a denser and thicker solution when compared with the other two films, which makes the water evaporation in the heating process harder, and thus, the most noticeable wrinkles when dried. In the films with the probiotic LGG, the rod-like shaped bacteria with a size of ˜1 μm can be seen. In order to confirm the homogenous distribution of LGG in films, EDX mapping was used. As every bacterium strain contains proteins and phospholipids in its structure, the groups have been identified as “N” groups (Blue dots) and “P” groups (purple dots). The good distribution of N and P groups is a sign of the presence and dispersion of LGG in the films.

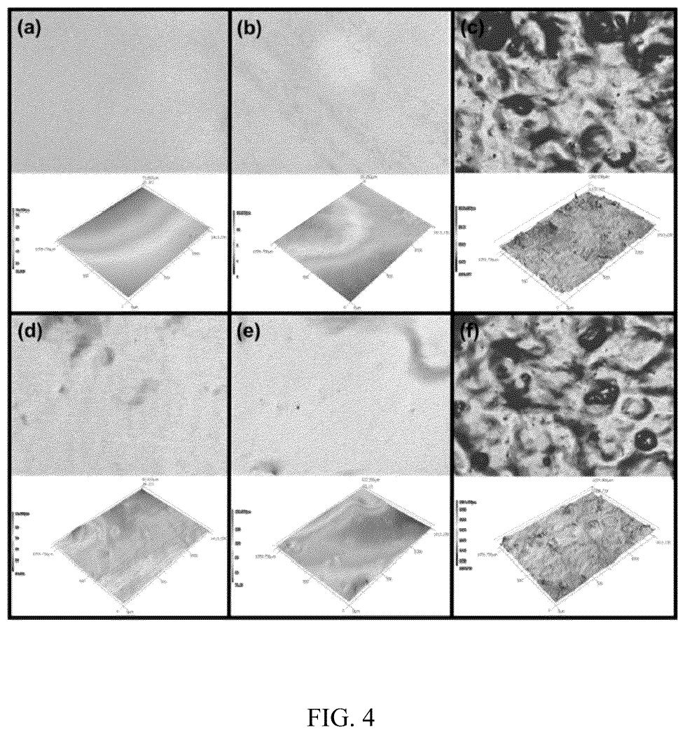

The microstructure and 3D topographical framework of the films were observed using laser scanning confocal microscopy and are shown in FIG. 4, panels (a)-(f), wherein panels (a)-(f) are as follows: quince (panel a), flax (panel b), basil (panel c), quince-B (panel d), flax-B (panel e), basil-B (panel f). As can be seen in panel 4(a) and 4(b), both Quince and Flax exhibited a smooth surface, while the Basil sample (panel 4(c)) exhibited a rough surface with a porous structure, which could be due to the left-over seed parts that could not be removed from its structure during film preparation. Upon addition of the probiotics, the roughness of the films increased (panels 4(d)-4(f)) compared to the control samples, which is indicative of the pin-holes caused by the presence of the LGG. The bacterial cells were embedded in the film matrix that could result in an increase of the roughness. These results were previously confirmed by SEM and WVP results.

To quantitatively study the surface roughness of the films, average surface roughness (Ra) was measured. Ra values for Quince, Flax, and Basil were found 2.2, 1.6, and 5.5 μm, respectively. Upon the addition of LGG, Ra values for Quince-B, Flax-B, and Basil-B increased to 3.1, 3.9, and 7.6 μm, respectively. This increase can be attributed to the presence of the tiny rod-like bacteria embedded in the films. It is important that films do not introduce roughness or color changes to the produce that would discourage consumers. Any increase in the roughness of a film can change the texture and appearance of the coated produce. Quince and flax films are better candidates for edible film applications because they exhibited lower roughness than the Basil films regardless of the presence of LGG.

### Viability of Probiotics in Films During Storage

The viability of the probiotics can be affected by storage temperature, duration, and humidity. Table 5, section (A) shows the viability of LGG embedded in films during storage at 4 and 25° C. All samples showed no significant decrease in probiotic viability during the drying process (initial day). As the temperature has a direct effect on the survivability of the bacteria, all the films stored at room temperature showed a greater reduction in a viable number of probiotics compared with the samples stored at 4° C. (p<0.05). The Quince-B film demonstrated the highest LGG viability among the samples by showing ˜2 log CFU reduction at the end of storage at 4° C. and ˜3 log CFU reduction at 25° C. Based on the viability percentage of Quince-B film, 71 and 61% of the samples survived after 5 weeks of storage at 4 and 25° C., respectively. Flax-B film shows nearly one more log reduction comparing with the Quince B and the LGG survived in these films after 5 weeks of storage are 61 and 51% at 4 and 25° C., respectively. Finally, the Basil-B film demonstrates the lowest values of viability by showing nearly 5 (41%) and 7 (19%) log reduction during storage at 4 and 25° C., respectively. The quince formed a more homogenous film and protected the LGG better comparing with the other two mucilages, while the porous structure of the basil caused lower protection of probiotics.

TABLE 5
Viability of the probiotics during the storage in the films in fridge and room temperature

| | | Temperature | | Log CFU/g | | | | |
|---|---|---|---|---|---|---|---|---|
| | Samples | (° C.) | Initial | 7 days | 14 days | 21 days | 28 days | 35 days |
| (A) | Control (LGG | 25 | 9.06 ± 0.04 ^{a} | 8.09 ± 0.05 ^{a} | 7.23 ± 0.04 ^{c} | 5.30 ± 0.08 ^{d} | 3.23 ± 0.45 ^{d} | 1.65 ± 0.06 ^{e} |
| | in MQ) | 4 | 9.06 ± 0.04 ^{a} | 8.47 ± 0.04 ^{a} | 7.66 ± 0.03 ^{a} | 6.06 ± 0.08 ^{c} | 5.39 ± 0.12 ^{b} | 3.30 ± 0.23 ^{d} |
| | Quince-B | 25 | 8.87 ± 0.09 ^{b} | 7.29 ± 0.39 ^{b} | 7.42 ± 0.04 ^{b} | 7.30 ± 0.24 ^{a} | 5.54 ± 0.25 ^{b} | 5.47 ± 0.06 ^{b} |
| | | 4 | 8.87 ± 0.09 ^{b} | 8.57 ± 0.09 ^{a} | 7.67 ± 0.07 ^{a} | 7.52 ± 0.03 ^{a} | 6.41 ± 0.27 ^{a} | 6.36 ± 0.16 ^{a} |
| | Flax-B | 25 | 8.89 ± 0.01 ^{b} | 7.54 ± 0.10 ^{b} | 7.56 ± 0.25 ^{b} | 7.13 ± 0.03 ^{b} | 5.81 ± 0.07 ^{b} | 4.56 ± 0.05 ^{c} |
| | | 4 | 8.89 ± 0.01 ^{b} | 8.54 ± 0.41 ^{a} | 8.21 ± 0.40 ^{a} | 7.65 ± 0.18 ^{a} | 5.73 ± 0.29 ^{b} | 5.39 ± 0.23 ^{b} |
| | Basil-B | 25 | 8.58 ± 0.10 ^{c} | 6.30 ± 0.59 ^{b} | 5.75 ± 0.01 ^{e} | 4.90 ± 0.07 ^{e} | 2.79 ± 0.24 ^{e} | 1.68 ± 0.09 ^{e} |
| | | 4 | 8.58 ± 0.10 ^{c} | 7.17 ± 0.48 ^{b} | 6.80 ± 0.16 ^{d} | 5.15 ± 0.04 ^{d} | 4.32 ± 0.27 ^{c} | 3.60 ± 0.13 ^{d} |

| | | Inactivation rate at 4° C. | | Inactivation rate at 25° C. | |
|---|---|---|---|---|---|
| | Samples | k_{T4} (log CFU/g day⁻¹) | R² | k_{T25} (log CFU/g day⁻¹) | R² |
| (B) | Quince-B | 0.078^{c} | 0.941 | 0.081^{c} | 0.893 |
| | Flax-B | 0.108^{b} | 0.913 | 0.111^{b} | 0.902 |
| | Basil-B | 0.143^{a} | 0.976 | 0.187^{a} | 0.963 |

^{a,b,c,d,e}Different letters in the same column indicate significant differences (a > b > c > d > e; p < 0.05). Values were given as mean ± standard deviation

The inactivation curves of LGG incorporated into the mucilage based edible films are obtained by plotting the Log(N/N₀) vs time. The inactivation rate, as well as the R² coefficient, are reported in Table 5, section (B). In all samples, regardless of the storage temperature, inactivation of LGG followed first-order kinetics. It is also observed that the samples show a slightly higher inactivation rate upon storage at 4° C. Interestingly, no significant differences in the stability of LGG in the Quince-B and Flax-B at different temperatures were observed, and Quince-B showed the lowest inactivation rate compared to the other samples because the water activity of this sample is slightly higher than other films. Basil-B, as expected, based on the viability tests, shows the highest inactivation of probiotics at different temperature (p<0.05).

### Coating Applications

To study the effect of films on the shelf life of fruit and vegetables, films were applied to the surface of samples via a common dip-coating method. Among the three seed mucilage types tested, flax and quince were observed to be the more optimal materials due to having better physical and mechanical properties.

Therefore, for a qualitative coating application, produce was coated with Quince, Flax, Quince-B and Flax-B. Before the coating process, fresh strawberries, bananas, cucumbers, and cherry tomatoes were immersed in sodium hypochlorite (1%) for 15 min, washed with tap water and left to dry for 2 h. Then the fruits and vegetables dipped into the as-prepared mucilage aqueous solution for 2-3 min and then air dried.

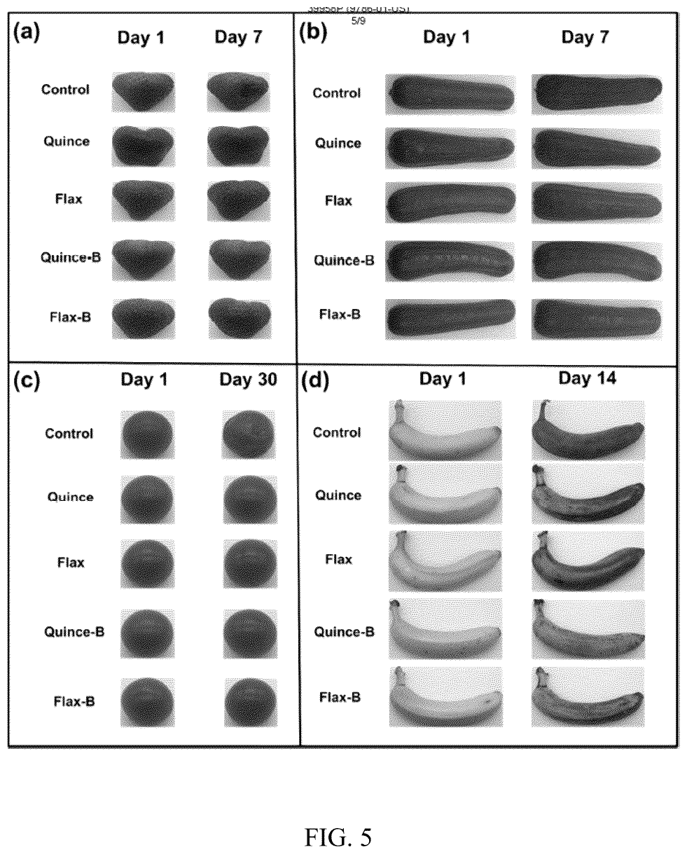

As shown in FIG. 5 (panel a), mold formed on the surface of the uncoated strawberries, which were stored in the fridge (˜4° C.), within a week. The mucilage-coated strawberries, however, with all of the films, were brighter and showed lower water loss compared with the control. The presence of LGG preserved the fruit's original appearance after one week. In the case of cucumbers and cherry tomatoes (FIG. 5, panels b and c), water loss was the major phenomenon in the studied period (7 days for cucumber and 30 days for cherry tomatoes). The tomato and cucumber appearances were slightly shiny in the case of mucilage coated samples as compared with the control. After 1 month of storage, the water loss in the tomato was readily observable in the control sample, while the appearance of the mucilage-coated samples remained unchanged. For cucumbers, after 7 days, the control sample showed evidence of dehydration (wrinkled surface), while the Quince and Flax coated samples show only a slight water loss. The cucumbers coated with the bacteria-containing mucilage showed almost no change after 7 days.

The banana samples (FIG. 5, panel d) however, showed a visible difference between all the samples. The control sample was completely brown after two weeks, while the banana coated with the films were noticeably less brown. Further, the Quince film-coated banana was less brown when compared with the banana coated with the Flax film. This could be due to the fact that the films can protect the surface from oxidation which result in discoloration. This is more interesting when it is observed that the samples coated with the Quince-B and Flax-B show even less brownish coloration (oxidation), which could be attributed to the activity of the bacteria as it inhibits metabolite formation.

Overall, there was no major difference in the results of most of the products coated with different mucilage films, except for the banana samples. The mucilage-coated samples maintained an improved appearance, which is indicative of the protective effect of the prepared films. Furthermore, it is known that the presence of lactic acid bacteria in films not only improves health when they are consumed but they can also improve protective abilities by competing with other bacteria and pathogens for nutrients alongside producing organic acids and bacteriocins as metabolites during storage. Therefore, products coated by mucilage containing LGG films remained fresher for a longer period of time.

### CONCLUSION

In the current study, edible films and coatings based on natural mucilage incorporated with lactic acid probiotic strain LGG were fabricated and fully characterized. The characteristics of the films were slightly affected by the addition of LGG to their formulation. According to the FTIR results and thermal properties, addition of bacteria did not change the structure of the samples. Among the three seed mucilage types investigated, flax and quince were observed to produce superior films that are more mechanically robust for edible films. They have a higher tensile strength while maintaining the favorable properties of water solubility and high moisture retention. Upon addition of LGG, the mechanical properties, such as tensile strength and elongation at break, were only slightly decreased. The films showed similar water activity and moisture content regardless of the seed type and presence of probiotics, while the addition of LGG increased the solubility of the films and surface roughness. According to the observed solubility results, quince-based samples show lower solubility and could maintain their structure and prevent water evaporation. Addition of LGG did not change the WVP of the quince, while it increased the WVP values in other films. All films showed hydrophilic properties, and upon addition of LGG, hydrophilicity decreased. The morphological studies confirmed even distribution of the LGG throughout the films and showed that the addition of LGG slightly increased the roughness.

Interestingly, different mucilage types demonstrated different surface energy and the addition of LGG increased quince surface energy, while the flax exhibited very high surface energy regardless of the presence of LGG. The flax and quince-based films were effective at filtering UV light; however, the addition of probiotic LGG resulted in a considerable reduction in transparency. Quince showed the highest transparency values regardless of the presence of the LGG, while Basil showed the lowest transparency. The Quince-B film showed the highest LGG viability among the samples by showing ˜71% and 61% viability of the LGG after 5 weeks of storage at 4° C. and 25′° C. respectively. The inactivation rate of LGG in Quince-B and Flax-B were not significantly different at different temperatures, and Quince-B showed the lowest inactivation rate comparing with the other samples.

Finally, the potential use of the prepared films was investigated in a coating experiment on fruits and vegetables. Quince-B showed the best results in all the coatings compared to the other samples. The results of this study indicate that seed mucilage, especially quince, is a viable support material for probiotics. Therefore, based on these results, mucilage of different parts of the plants such as leaves, middle lamella, barks, and root could also be used. These waste materials could produce value-added materials through the extraction of mucilage and production of films. These probiotic films are completely natural, and thus, useful in sustainable food coating applications.

While there have been shown and described what are at present considered the preferred embodiments of the invention, those skilled in the art may make various changes and modifications which remain within the scope of the invention defined by the appended claims.

1.-41. (canceled)

42. A method of extending the lifetime and increasing the nutritive value of a fruit or vegetable, the method comprising:
(i) coating the fruit or vegetable with a probiotic-containing mucilage solution; and
(ii) drying the coating to produce an edible film comprising dried mucilage and the probiotic dispersed in the dried mucilage.

43. The method of claim 42, wherein the probiotic-containing mucilage solution is coated onto the fruit or vegetable by dipping or spraying the fruit or vegetable with the probiotic-containing mucilage solution.

44. The method of claim 42, wherein the mucilage is obtained from seeds, leaves, middle lamella, fruit, bark, or root of a plant.

45.-47. (canceled)

48. The method of claim 42, wherein the probiotic comprises Lactobacillus.

49. (canceled)

50. The method of claim 42, wherein the probiotic-containing mucilage solution further contains a plasticizer.

51. The method of claim 50, wherein the plasticizer comprises glycerol.

52. The method of claim 42, wherein the fruit or vegetable comprises a strawberry, cucumber, tomato, or banana.

53. A food product comprising:
a fruit or a vegetable; and
an edible film layer disposed on at least part of the fruit or vegetable wherein the edible film layer comprises a dried mucilage and a probiotic dispersed in the dried mucilage.

54. A food product of claim 53, wherein the dried mucilage is obtained from seeds, leaves, middle lamella, fruit, bark, or root of a plant.

55. A food product of claim 53, wherein the probiotic comprises Lactobacillus.

56. A food product of claim 53, further comprising a plasticizer.

57. A food product of claim 53, wherein the plasticizer comprises glycerol.

58. A food product of claim 53, wherein the edible film layer has a tensile strength of 5-20 MPa.

59. A food product of claim 53, wherein the edible film layer has an elastic modulus of 200-500 MPa.

60. A food product of claim 53, wherein the edible film layer has a thickness of 50-150 microns.

61. A food product of claim 53, wherein the edible film layer has a moisture content of greater than 90%.

62. A food product of claim 53, wherein the edible film layer has a water activity below 0.6.

63. A food product of claim 53, wherein the edible film layer exhibits a probiotic viability of at least 7.0 log CFU/g after 21 days at room temperature.

64. A food product of claim 53, wherein the edible film layer possesses a water vapor permeability (WVP) of no more than 40×10″⁸ g/h·m·Pa after 14 days.

65. A food product of claim 53, wherein the edible film layer has a tensile strength of 10-20 MPa, an elastic modulus of 300-500 MPa, a thickness of 100-130 microns, a moisture content of greater than 90%, a water activity below 0.6, a water vapor permeability (WVP) of no more than 40×10″⁸ g/h·m·Pa after 14 days, and exhibits a probiotic viability of at least 7.0 log CFU/g after 21 days at room temperature.

66. A food product of claim 53, wherein the edible film layer further comprises food color, flavoring agent, sweetener, natural wetting agent, fragrance, essential oil, or any combinations thereof.

67. A food product of claim 53, wherein the edible film layer further comprises fructan, galactan, resistant starch, xylooligosaccharides, pectin, or beta-glucans.

68. A food product of claim 53, wherein the edible film layer possesses a water vapor permeability (WVP) of no more than 40×10-8 g/h·m·Pa after 14 days and the appearance of the fruit or vegetable shows substantially no change after 7 days.
